(19) United States
(12) Patent Application Publication
(10) Pub. No.: US 2026/0258623 A1
(43) Pub. Date: Sep. 3, 2026

(54) MODULAR PLATFORM FOR RETRIEVING WATER SURFACE FLOATING CONTAMINANTS

(71) Applicant: Sheco. Inc., Incheon (KR)

(72) Inventors: Sang Hoon HAN, Incheon (KR); Gi Sung KWON, Incheon (KR); Hong Min KIM, Incheon (KR); Jong Yun KIM, Incheon (KR)

(21) Appl. No.: 19/400,172

(22) Filed: Nov. 25, 2025

(30) Foreign Application Priority Data
Jan. 31, 2025 (KR) 10-2025-0012545

(51) Int. Cl. E02B 15/10; B63B 35/32; C02F 1/00; C02F 1/40; C02F 101/32; C02F 103/00; E02B 15/04

(52) U.S. Cl. CPC E02B 15/10; B63B 35/32; C02F 1/001; C02F 1/008; C02F 1/40; E02B 15/045; E02B 15/046; C02F 2101/32; C02F 2103/007; C02F 2201/007; C02F 2201/008

(57) ABSTRACT

The present invention relates to a modular platform for retrieving water surface floating contaminants, and may include: a Body part including a main frame; a Contaminated matter inlet disposed at a front part of the Body part and receiving contaminants; a Propulsion body provided in the Body part and exerting a propulsion force to move the Body part in a desired direction; and Add-on equipment detachably coupled to a rear or an interior of the Body part.

### CROSS-REFERENCE TO RELATED APPLICATIONS

This application claims priority to and the benefit of Korean Patent Application No. 10-2025-0012545, filed on Jan. 31, 2025, the disclosure of which is incorporated herein by reference in its entirety.

### BACKGROUND

### 1. Field

The present invention relates to an apparatus, etc. for retrieving contaminants floating on a water surface.

An example of the contaminants may be oil, or may be oil water in which water and oil are mixed. Mainly, it deals with contaminants in a fluid state (i.e., oil or oil water, etc.), but sometimes it can also handle marine debris in a solid state. The marine debris in a solid state does not necessarily need to be floating, and a part or all of it may be below the water surface.

A specific example of the present invention is a marine spilled oil removal system and method using an aquatic response robot that has an AI camera and is capable of autonomous navigation, in a case where oil is spilled on a water surface (ocean or lake, etc.).

### 2. Description of Related Art

In a case where an accident occurs in which oil is spilled on a water surface such as an ocean or lake, it is necessary to prevent the oil from spreading widely by quickly performing response work.

An oil spill refers to the release of liquid petroleum hydrocarbons into the surrounding environment as a result of human activities, not intentionally. ‘Oil’ may be crude oil, refined oil, refined petroleum products (gasoline, diesel, etc.), or byproducts, ship's bunker oil, or oily waste. The spilled oil may take several months to several years to clean up.

To remove such spilled oil, methods such as deploying emulsifiers or hygroscopic agents on the sea, removal using absorbent pads, or removal using automated oil-water separators, etc., are used.

For example, when performing such response work, a method is being used in which, after installing an oil fence on the periphery of the area where oil is spilled, a worker throws a rectangular absorbent pad, which is made of non-woven fabric or the like, into the inside of the oil fence, lets the absorbent pad absorb the oil, and then removes the oil through a method of manually collecting the absorbent pad.

However, when performing response work with this method, because the absorbent pad must be thrown precisely onto the area where the oil is spilled, not only is it difficult to effectively control the oil distributed over a wide area, but also because a worker must collect the absorbent pad that has absorbed the oil, a problem has occurred in that collection takes a lot of time.

In particular, in this way, when a worker manually collects the absorbent pad, the worker is exposed to oil, and in particular, a problem has occurred in that health problems are caused by the worker inhaling oil vapor evaporated from the oil.

Therefore, recently, various marine response apparatuses for solving these problems have been developed and are being used.

However, because these marine response apparatuses are installed and used on large ships, there was a problem in that movement is inconvenient and it is difficult to quickly deploy them to the site.

Furthermore, with these marine response apparatuses, an operator of the ship must check the location where the oil is floating with the naked eye and move the ship to the location of the oil, and in this way, there was a problem in that it is very difficult for a person to check the oil floating far away with the naked eye.

Furthermore, in this way, the response work of controlling oil floating on the water surface takes a lot of time, and as described above, when an operator checks the location of the oil with the naked eye and operates the ship, the operator easily feels fatigue, causing a problem in that continuous response work cannot be performed for a long time.

In addition to the method using absorbent pads, automated oil-water separation methods such as Weir Skimmers, Oleophilic Skimmers, Conveyor Skimmers, Hydro-Dynamic Skimmers, mobile and fixed (ship-mounted) oil recovery units, Vacuum Skimmers, etc., are known, but all of these apparatuses are installed and used on large ships.

In Korea, oil spill accidents occur about 270 times per year on average, and the amount of spilled oil reaches 700,000 L. Most oil spills are small-scale accidents of 100 L or less, and this accounts for 70% of the frequency of all accidents. The problem is that existing automated equipment is all expensive, large-scale equipment, and due to the reason that different equipment must be used depending on the type of oil, it is mainly used for large-scale oil spill accidents, and small-scale accidents are mostly conventional, labor-intensive absorbent pad operations.

In that process, as described above, industrial accidents such as oil odor, headaches, and back pain occur to the responders, and naturally, working hours increase, making initial response difficult, and the amount of waste increases.

Therefore, a new method or apparatus for solving these problems has become necessary.

### SUMMARY

An object of the present invention is to obtain an oil recovery apparatus capable of performing various functions with a single platform.

Furthermore, another object is to facilitate distance measurement with objects to reduce a risk of collision or to provide assistance during avoidance navigation.

Furthermore, another object is to facilitate assembling and disassembling a net or a net fence.

Furthermore, another object is to enable state tracking of an actuator of the oil recovery apparatus.

Furthermore, another object is to enable accurate estimation of a waste retrieval amount.

The technical objects of the present invention are not limited to the technical objects mentioned above, and other unmentioned technical objects will be clearly understood by one of ordinary skill in the art from the description below.

According to the present invention, a water surface floating contaminant retrieval apparatus is provided,
(i) a hull including a main frame;
(ii) a Contaminated matter inlet disposed at a front part of the hull and receiving contaminated water;
(iii) a Propulsion body exerting a propulsion force to move the hull in a desired direction;
a platform comprising the same, and
(iv) an oil recovery part storing the contaminated water introduced through the Contaminated matter inlet; an oil recovery part filter disposed at a lower end of the oil recovery part and filtering water separated to the lower part when the contaminated water is separated by a density difference, oil is separated on top, and water is separated below; and a cartridge storing the oil separated on top, or
(v) a net installed at a rear of the hull, wherein the net functions as a solid contaminant retrieval module for retrieving solid contaminants included in the contaminated water introduced into the hull of the floating contaminant retrieval apparatus through the Contaminated matter inlet, or
(vi) a net fence installed rearward of the Contaminated matter inlet, wherein one end of the net fence is installed at a rear of the hull of the water surface floating contaminant retrieval apparatus (hereinafter, also referred to as a first water surface floating contaminant retrieval apparatus), and the other end of the net fence is installed at a rear of the hull of a separate water surface floating contaminant retrieval apparatus (hereinafter, also referred to as a second water surface floating contaminant retrieval apparatus), wherein the net fence functions as a fence module for retrieving water surface floating contaminants between the first water surface floating contaminant retrieval apparatus and the second water surface floating contaminant retrieval apparatus,
further comprising Add-on equipment which is any one of the foregoing (iv), (v), and (vi),
wherein the apparatus is configured such that (iv) can be detached from and attached to the platform, (v) can be detached from and attached to the platform, and (vi) can be detached from and attached to the platform.

Preferably, the Propulsion body further comprises a Propulsion body guard around its periphery,
wherein the Propulsion body guard, in a longitudinal direction of the water surface floating contaminant retrieval apparatus,
(a) a middle region, which is a region overlapping with the Propulsion body, (b) a front region, which is a region in front of the Propulsion body, (c) a rear region, which is a region behind the Propulsion body comprises:
wherein the middle region, the front region, and the rear region are surrounded by a mesh, a first open space, where the mesh is not installed, is present between the middle region and the front region, and a second open space, where the mesh is not installed, is present between the middle region and the front region,
and wherein the middle region moves forward to contact the front region such that the first open space disappears and the second open space becomes larger, or the middle region moves rearward to contact the rear region such that the first open space becomes larger and the second open space disappears.

Preferably, the net of (v) or the net fence of (vi) is coupled to a rear of the hull through a Connecting link.

Preferably, the Connecting link comprises a first ring and a second ring,
wherein the first ring is connected to the hull, and the second ring is connected to the net of (v) or the net fence of (vi),
and wherein the first ring and the second ring face each other.

Preferably, the first ring and the second ring are connected to a pole, and then, by moving the pole, allowing the first ring to be connected to the hull, and allowing the second ring to be connected to the net of (v) or the net fence of (vi), and thereafter separating the pole from a combination of the first ring and the second ring, the first ring and the second ring are connected to the hull and the net or the net fence.

Preferably, not only an input electrical signal but also an output electrical signal of the Propulsion body, which is an actuator of the water surface floating contaminant retrieval apparatus, are monitored, thereby inferring a state of the actuator of the water surface floating contaminant retrieval apparatus.

Preferably, the input electrical signal is current or electric power, and the output electrical signal is current or electric power.

Preferably, by comparing a numerical value in the input electrical signal and a numerical value in the output electrical signal, feedback is obtained on whether the actuator actually moved as commanded.

Preferably, a capacity is primarily estimated by utilizing an aquatic monitoring camera so that an amount of solid marine debris retrieved by the water surface floating contaminant retrieval apparatus can be known, and furthermore, the amount of retrieved marine debris is secondarily estimated through an input electrical signal, an output electrical signal, and driving speed data, which are input to the Propulsion body that is the actuator of the water surface floating contaminant retrieval apparatus.

Preferably, the primary estimation and the secondary estimation comprise: a step of analyzing a contaminant collection amount through an image obtained from a camera installed on an upper part of the water surface floating contaminant retrieval apparatus; and a step of reinforcing a marine debris amount estimation value.

Preferably, the step of reinforcing the marine debris amount estimation value comprises:
estimating a driving speed of the water surface floating contaminant retrieval apparatus (hereinafter, referred to as ‘Speed A’) through data from GPS and IMU (Inertial Measurement Unit) sensors, and also monitoring data of the input electrical signal and the output electrical signal of the Propulsion body;
acquiring a driving speed of the robot (hereinafter, referred to as ‘Speed B’) corresponding to the current input electrical signal and the current output electrical signal, based on a pre-calculated propulsion speed table;
determining a speed propulsion degradation level of the water surface floating contaminant retrieval apparatus through a difference between the Speed A and the Speed B; and
reinforcing the numerical value of the marine debris amount estimated by the camera, according to the determined speed propulsion degradation level.

Preferably, the pre-calculated propulsion speed table refers to a data table in which the propulsion speed of the water surface floating contaminant retrieval apparatus is calculated based on data of the input electrical signal and the output electrical signal of the Propulsion body in an environment without currents and waves.

Preferably, the apparatus further comprises:
an inlet impeller installed at the Contaminated matter inlet and introducing contaminated water into the hull;
an inlet impeller housing surrounding the inlet impeller; and
a Water splash prevention shield installed at an upper part of an upstream portion of the inlet impeller housing.

Preferably, the apparatus further comprises:
a buoyancy device connected to the hull or being a part of the hull,
and wherein the hull and the buoyancy device have a buoyancy set such that the inlet impeller is 40% to 60% submerged.

Preferably, the apparatus further comprises:
a first flow separation plate installed on the hull, installed at a height of a sea level, and having a shape extending rearward and then extending downward again;
a first vertical baffle installed rearward of the first flow separation plate, and having an upper opening and a lower opening;
an upper horizontal baffle installed rearward of the first vertical baffle, and having a first filter for filtering oil; and
a lower horizontal baffle installed below the upper horizontal baffle, and having a second filter with a denser mesh net than the first filter,
wherein the lower horizontal baffle is installed across a lower part of the first vertical baffle and the upper horizontal baffle, or is installed across a lower part of the first flow separation plate, the first vertical baffle, and the upper horizontal baffle,
and wherein fluid that flows through the lower opening of the first vertical baffle is configured to be introduced to a side lower part of the upper horizontal baffle after passing through a pocket groove,
and wherein fluid that flows through the upper opening of the first vertical baffle is configured to be introduced to an upper part of the upper horizontal baffle.

Preferably, in the cartridge of (iv), a cartridge partition formed vertically is formed inside the cartridge, and delay or filtering of the flow of the contaminated water is performed by the cartridge partition, such that the contaminant is separated.

Preferably, the cartridge partition comprises a first partition closer to an inlet to the cartridge, and a second partition farther from the inlet, wherein a separation force of the second partition is higher than a separation force of the first partition.

Preferably, at a lower end of a section farthest from the inlet to the cartridge among sections separated by the cartridge partition, a buoyant body exists that can move from a first height below to a second height above, wherein the buoyant body has an intermediate specific gravity between the contaminant and water, wherein as the contaminant, which has a lower specific gravity than water, rises in an upper part of the farthest section, the buoyant body descends downward along a boundary between the contaminant and the water, and wherein when the buoyant body descends to a predetermined height at a position corresponding to a predetermined contaminant storage capacity of the cartridge, a sensor detects this.

Preferably, among the three spaces partitioned by the first partition and the second partition, when the space closest to the inlet to the cartridge is referred to as a first stacking space, the space between the first partition and the second partition is referred to as a second stacking space, and the space farthest from the inlet to the cartridge is referred to as a third stacking space, a discharge hole and a means for opening and closing the discharge hole are formed in the first stacking space.

Preferably, a filter is disposed at a lower part of the third stacking space, and a filter part hole and a means for opening and closing the filter part hole are formed above the filter.

According to the present invention, as a Connecting equipment, comprising the aforementioned pole, the first ring, and the second ring, wherein the first ring and the second ring are connected to the pole, and then, by moving the pole, allowing the first ring to be connected to the hull, and allowing the second ring to be connected to the net of (v) or the net fence of (vi), and thereafter separating the pole from a combination of the first ring and the second ring, thereby causing the first ring and the second ring to be connected to the hull and the net or the net fence, a Connecting equipment is provided.

### BRIEF DESCRIPTION OF THE DRAWINGS

FIG. 1A is a perspective view of an apparatus according to an embodiment (first embodiment) of the present invention, seen obliquely from above.

FIG. 1B is a perspective view of the apparatus according to an embodiment of the present invention, seen obliquely from below.

FIG. 1C is a front view of the apparatus according to an embodiment of the present invention.

FIG. 1D is a rear view of the apparatus according to an embodiment of the present invention.

FIG. 1E is a top view of the apparatus according to an embodiment of the present invention.

FIG. 1F is a bottom view of the apparatus according to an embodiment of the present invention.

FIG. 1G is a right side view of the apparatus according to an embodiment of the present invention.

FIG. 1H is a left side view of the apparatus according to an embodiment of the present invention.

FIG. 2A is a diagram showing another embodiment (second embodiment) of the present invention, which has a somewhat different outer appearance from that of FIGS. 1A to 1H (the first embodiment of the present invention).

FIG. 2B is a partially enlarged view of FIG. 2A.

FIG. 2C is a side cross-sectional view near the inlet 20 in the embodiment of FIG. 2A.

FIG. 2D is a cross-sectional view of the apparatus of an embodiment of the present invention shown in FIG. 2A, seen from above.

FIG. 2E is a side cross-sectional view showing an interior of the water surface floating layer removal apparatus according to an embodiment of the present invention, and FIG. 2f is a perspective cross-sectional view of the same part.

FIG. 2F shows in detail a part schematically shown in FIG. 2E.

FIG. 3 is a diagram showing other embodiments (Embodiments 3 to 6) of the present invention.

FIG. 4A is a diagram showing the apparatus 10-4 of Embodiment 4 of the present invention.

FIG. 4B is a diagram for explaining the apparatus 10-4 of Embodiment 4 of the present invention by part.

FIG. 4C is an exploded perspective view of FIG. 4B.

FIGS. 5A, 5B, 5C, 5D and 5E are diagrams explaining the assembly and disassembly of the cartridge part before the deployment of the equipment 10-4.

FIGS. 6A, 6B and 6C are diagrams explaining a method of using the cartridge.

FIG. 7A is a diagram showing the apparatus 10-5 of Embodiment 5 of the present invention.

FIG. 7B is a diagram for explaining the apparatus 10-5 of Embodiment 5 of the present invention by part.

FIG. 7C is an exploded perspective view of FIG. 7B.

FIGS. 8A and 8B are diagrams explaining the assembly and disassembly of the net before the deployment of the equipment 10-5.

FIG. 9A is a diagram showing the apparatus 10-6 of Embodiment 6 of the present invention.

FIG. 9B is a diagram for explaining the apparatus 10-6 of Embodiment 6 of the present invention by part.

FIG. 9C is an exploded perspective view of FIG. 9B.

FIGS. 10A, 10B and 10C are diagrams explaining the assembly and disassembly of the net fence before the deployment of the equipment 10-6.

FIG. 11A is a diagram for explaining a controller (wireless controller, remote control).

FIGS. 11B, 11C, 11D, 11E and 11F also show explanations regarding the controller.

FIG. 12A shows a status LED.

FIG. 12B is a diagram regarding the washing of the equipment.

FIGS. 13A, 13B and 13C show a impeller guard according to the present invention.

FIG. 14 shows a Connecting equipment.

FIGS. 15A, 15B, 15C, 15D, 15E, 15F, 15G and 15H show Embodiment 7 of the present invention, and are mainly for explaining the cartridge 60.

FIG. 16 is an exploded perspective view schematically showing the overall configuration of a modular platform (Water robot) according to a new embodiment of the present invention.

FIG. 17 is a perspective view showing the basic platform shown in FIG. 16, that is, the Water robot 1600, in more detail.

FIG. 18 is a diagram showing in detail a process in which the oil recovery module 1700 according to an embodiment of the present invention is coupled to the Body part 1610 of the Water robot 1600.

FIG. 19 is a diagram showing a process in which the solid contaminant retrieval module 1800 according to an embodiment of the present invention is coupled to the Body part 1610 of the Water robot 1600.

FIG. 20 is a diagram showing a process in which the fence module 1900 according to an embodiment of the present invention is coupled to the Body part 1610 of the Water robot 1600.

### DETAILED DESCRIPTION

Advantages and features of the present invention, and methods of achieving them, will become clear by referring to the embodiments described in detail later together with the accompanying drawings. However, the present invention is not limited to the embodiments disclosed below but will be implemented in various different forms, and these embodiments are merely provided so that the disclosure of the present invention is complete, and to fully inform the scope of the invention to one of ordinary skill in the art to which the present invention pertains, and the present invention is only defined by the scope of the claims. Throughout the specification, the same reference numerals refer to the same constituent elements.

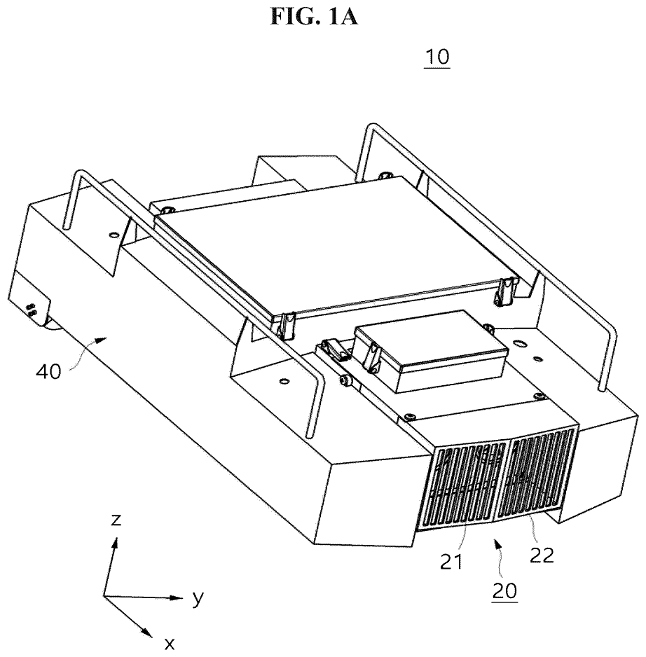

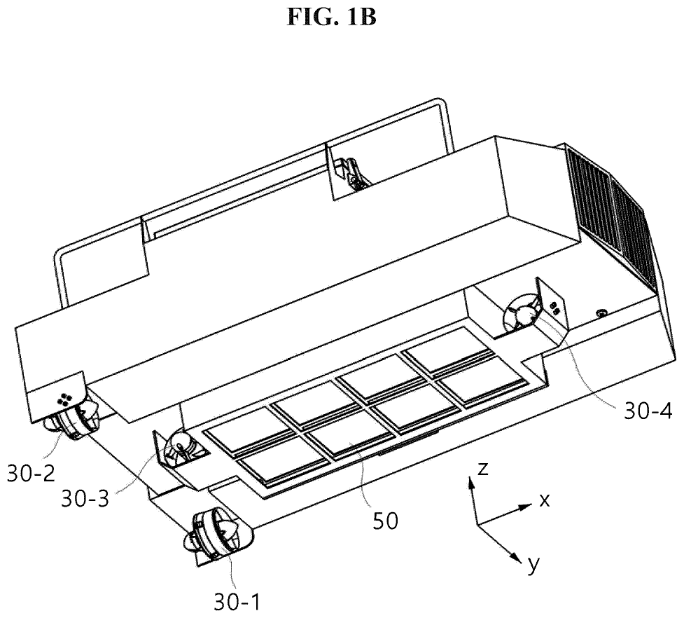

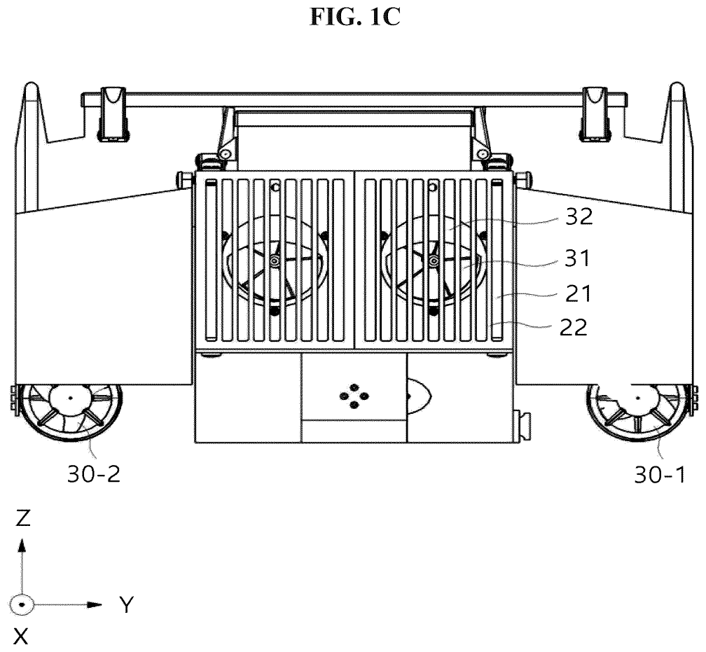

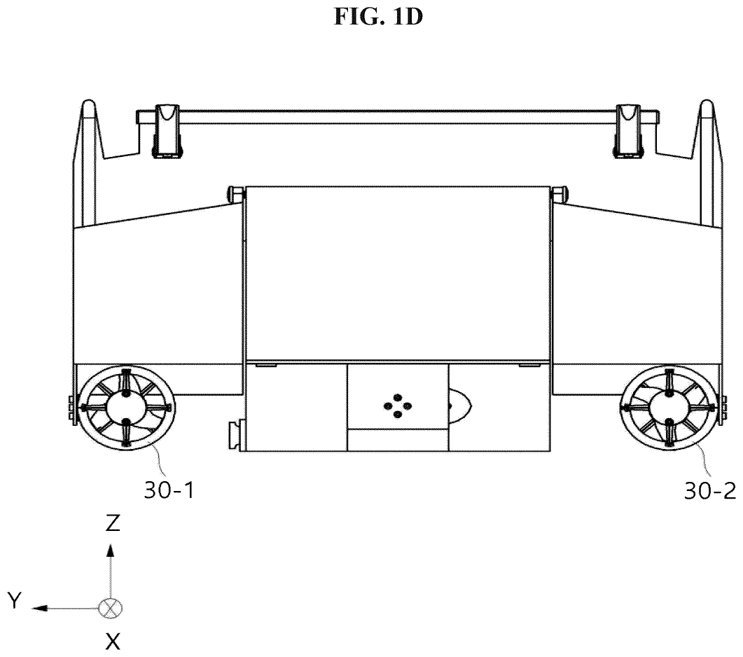

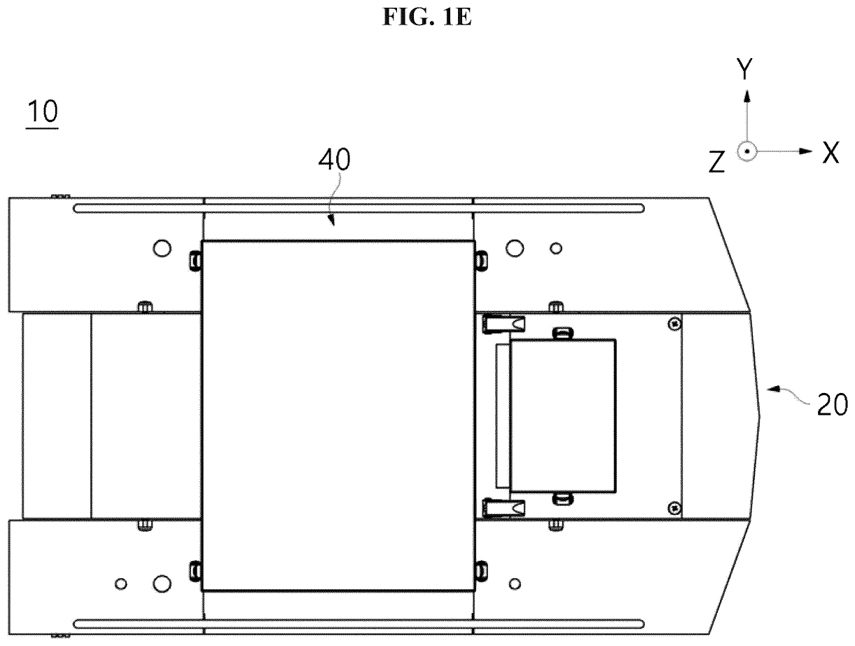

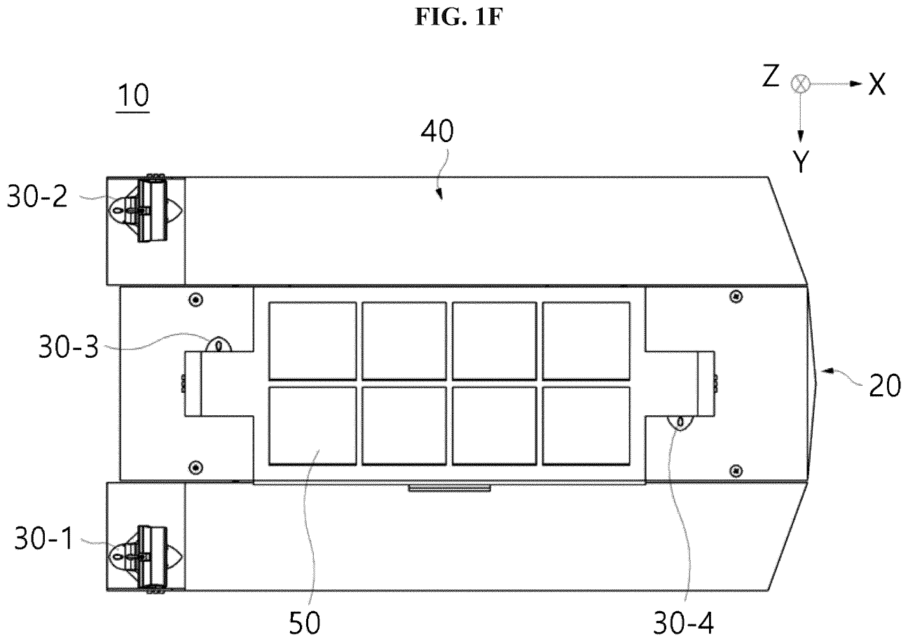

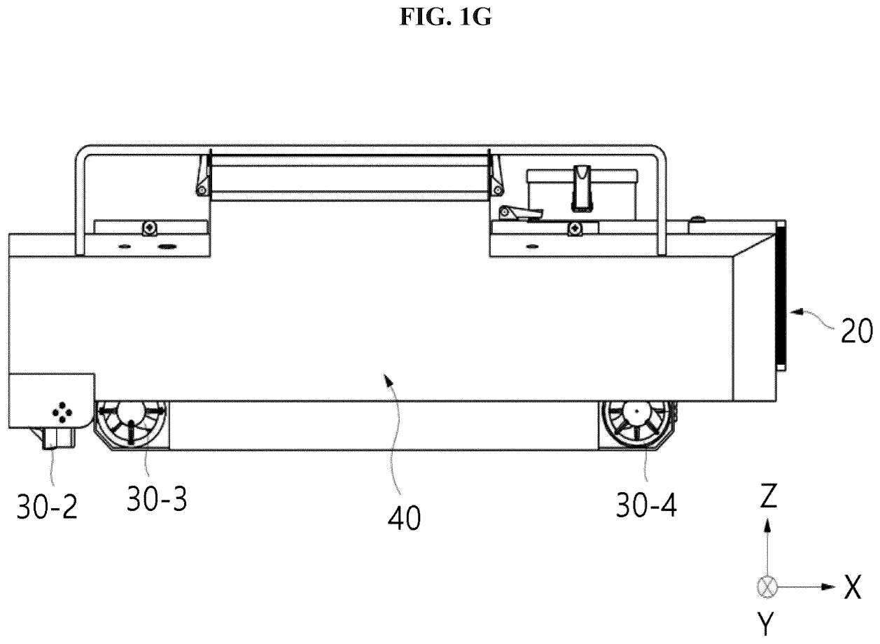

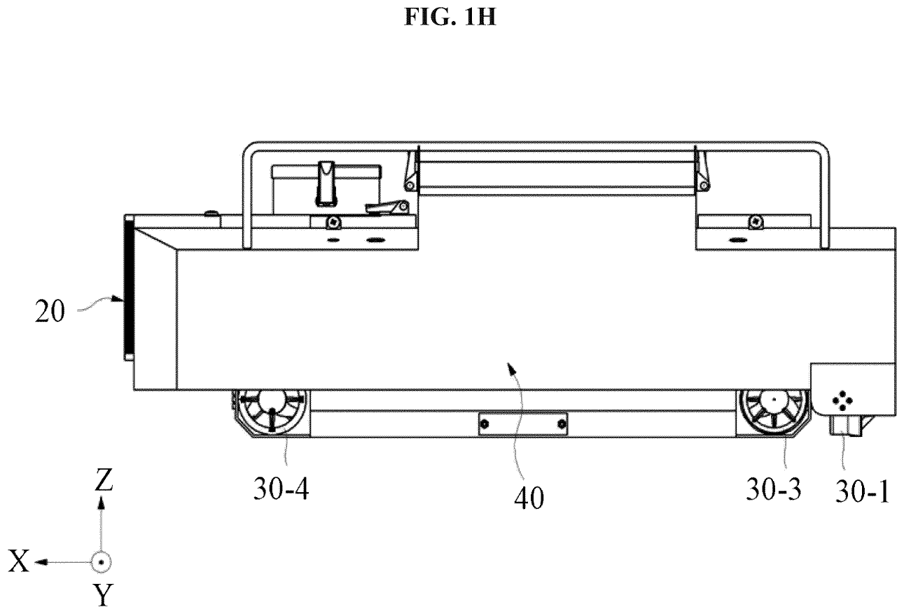

FIG. 1a is a perspective view of an apparatus according to an embodiment (first embodiment) of the present invention, seen obliquely from above.

The present invention is not limited to the illustration of FIG. 1a, and is presented as an example to explain the overall matters of the apparatus of the present invention.

For reference, the illustrations of FIGS. la to 1h may be referred to as a first embodiment of the present invention.

In the apparatus 10 of FIG. 1a (which may be called by various other names such as hull, oil recovery unit, oil recovery robot, robot, water surface floating layer retrieval apparatus, water surface floating layer removal apparatus, marine contaminant retrieval apparatus, marine debris retrieval apparatus, etc.), a contaminated water inlet 20 (contaminated water retrieval part) is disposed at a front surface of the movable hull 10. Behind the contaminated water inlet 20, a storage part 40 exists where the introduced contaminated water is stored. An interior of the contaminated water inlet 20 of the hull 10 and the storage part 40 is connected.

In a state where the hull 10 is floating on the water surface, the water surface comes to be within a height range of the inlet 21, allowing contaminated water to be introduced according to the advance of the hull 10, and this inlet 21 includes a filtering means 22 to block an influx of large-sized solids that can float in the contaminated water.

FIG. 1b is a perspective view of the apparatus according to an embodiment of the present invention, seen obliquely from below.

Impellers 30-1 and 30-2 are a means for moving the hull 10 of the apparatus forward and backward. Although two are shown, the number thereof is adjustable according to necessity.

Impellers 30-3 and 30-4 are a means for moving the hull 10 of the apparatus left and right. This also, although two are shown, the number thereof is adjustable according to necessity.

The position and number of Impellers 30-1, 30-2, 30-3, and 30-4 are not limited to the illustration, and in fact, in other embodiments described later, the position and number of the impellers (Propulsion bodies) are different.

The outlet 50 (discharge part) is a part where the water remaining after oil is separated from the introduced contaminated water is discharged. In this exemplary illustration, the outlet 50 is at a lower part of the hull 10, but according to necessity, it may be disposed on a rear surface, may be disposed at a lower end of the rear surface, or may be disposed at a rear part of a bottom surface.

FIG. 1c is a front view of the apparatus according to an embodiment of the present invention.

On the front surface, the filtering means 22 is seen, and behind it, the impeller 31 is seen. The entire surface of the impeller 31 is not seen, and its upper part is slightly covered by the Water splash prevention shield 32.

And, at a lower part, the aforementioned impellers 30-1 and 30-2 for forward and backward movement are shown.

In FIG. 1c, the impeller 31 is illustrated as a means for introducing/retrieving oil water (water and oil) at the inlet, but it is not necessarily limited to the use of the impeller 31, and for example, other examples using a pump or the like are also possible.

FIG. 1d is a rear view of the apparatus according to an embodiment of the present invention.

Here as well, at a lower part of the drawing, the aforementioned impellers 30-1 and 30-2 for forward and backward movement are shown.

FIG. le is a top view of the apparatus according to an embodiment of the present invention.

On the right side of the drawing, the contaminated water inlet 20 (contaminated water retrieval part) is seen, and because it is seen from above, structures such as the filtering means 22, the inlet 21, and the impeller 31 are not well seen.

And, the storage part 40 is shown, wherein both (left and right of the hull) outer walls of the storage part 40 may include a Buoyant body providing buoyancy. The buoyancy may be provided from the left and right sides of the storage part 40, and may be provided from the bottom side of the storage part 40. It will be preferable to provide buoyancy slightly from all of the left, right, and bottom sides of the storage part 40.

The degree of buoyancy is appropriate to submerge the impeller 31 by about half. Half does not mean exactly 50%, and may be about 40% to 60%. Depending on the case, it may be submerged by about 30% to 70%. Thus, by the action of the impeller 31 half-submerged in water, the contaminated water appropriately moves toward the storage part 40 inside the hull 10.

Of course, the impellers 30-1, 30-2, 30-3, and 30-4 that exert propulsion force for the forward, backward, left, and right movement of the hull are all submerged in water. Only the inlet impeller 31 disposed near the inlet 20 is submerged about half way in the water surface.

FIG. 1f is a bottom view of the apparatus according to an embodiment of the present invention.

The contaminated water inlet 20 (contaminated water retrieval part) is seen on the right side of the drawing, and the impellers 30-1, 30-2, 30-3, and 30-4 can be confirmed.

FIG. 1g is a right side view of the apparatus according to an embodiment of the present invention.

The contaminated water inlet 20 (contaminated water retrieval part) is seen on the right side of the drawing, and the side wall of the storage part 40 and the impellers 30-2, 30-3, and 30-4 can be confirmed.

FIG. 1h is a left side view of the apparatus according to an embodiment of the present invention.

The contaminated water inlet 20 (contaminated water retrieval part) is seen on the left side of the drawing, and the side wall of the storage part 40 and the impellers 30-1, 30-3, and 30-4 can be confirmed.

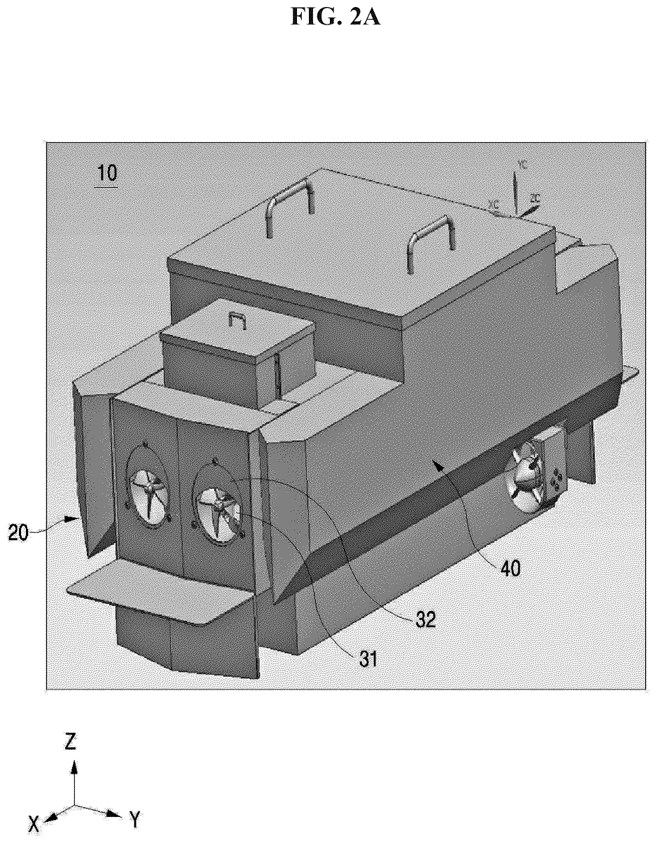

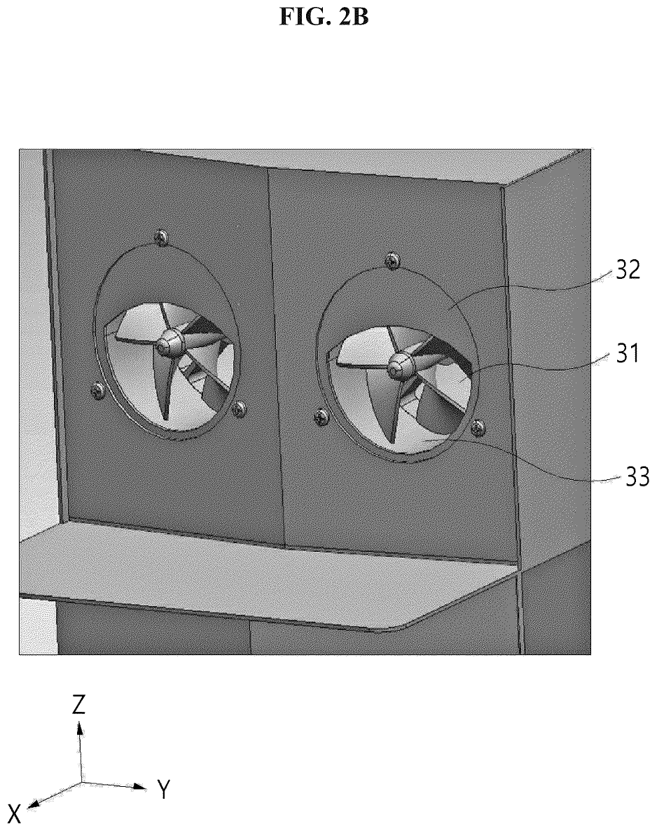

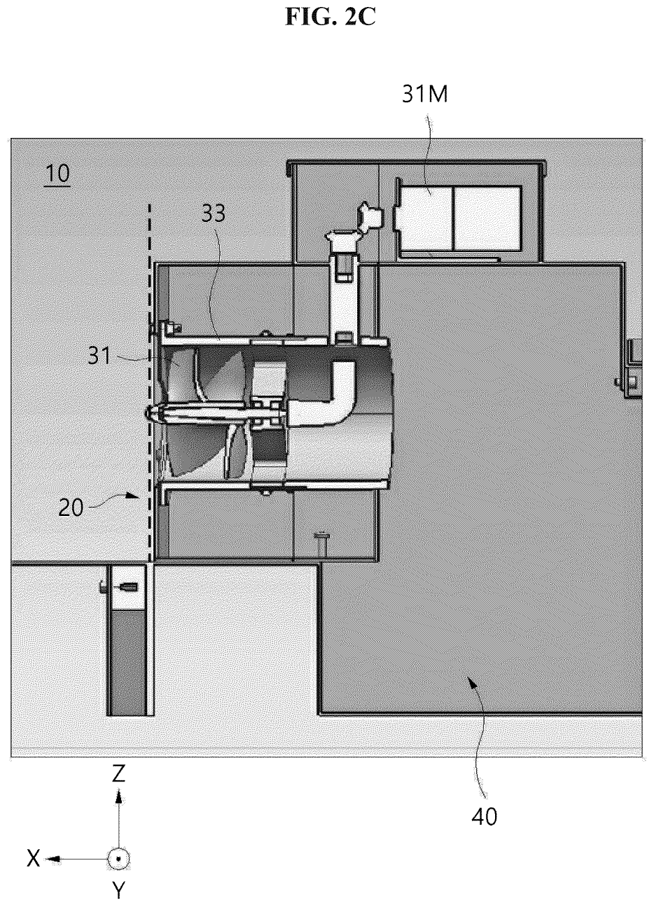

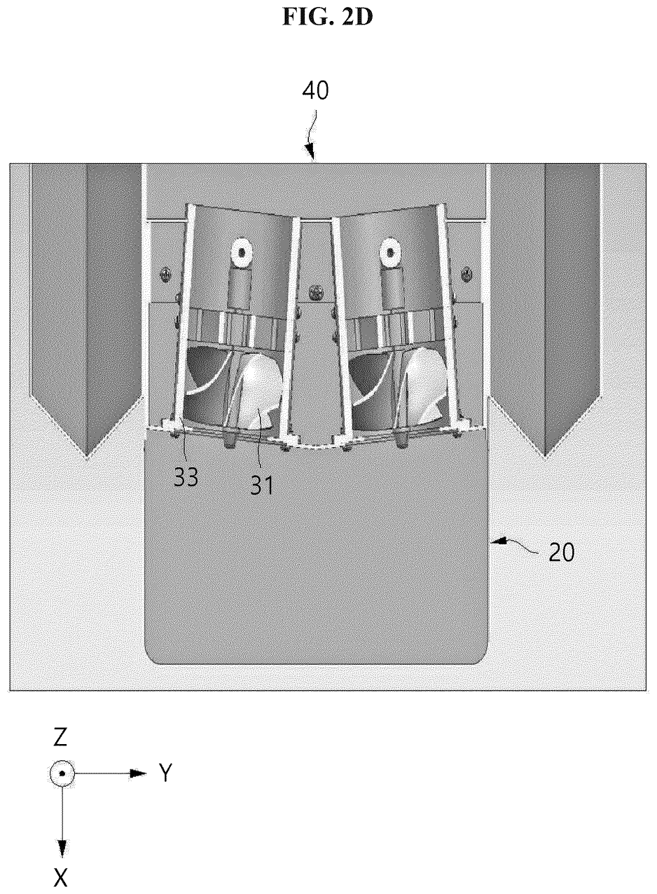

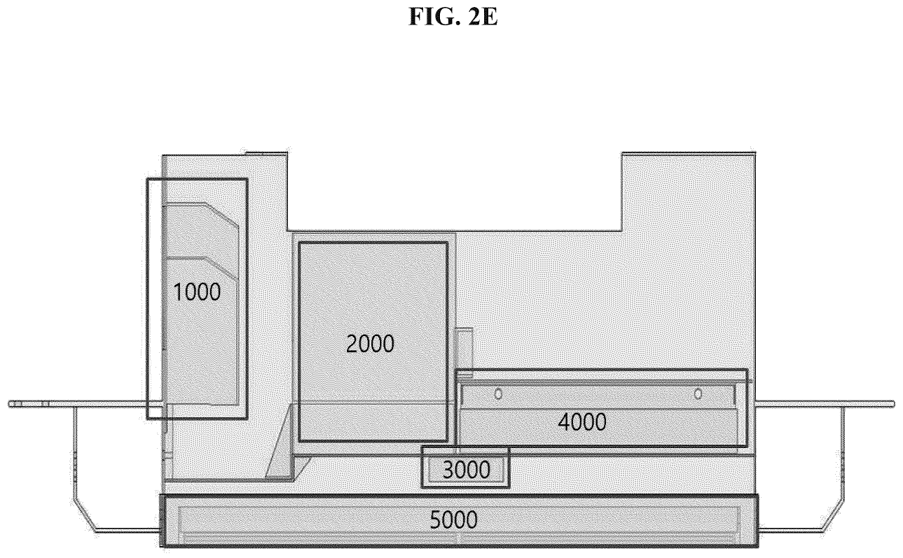

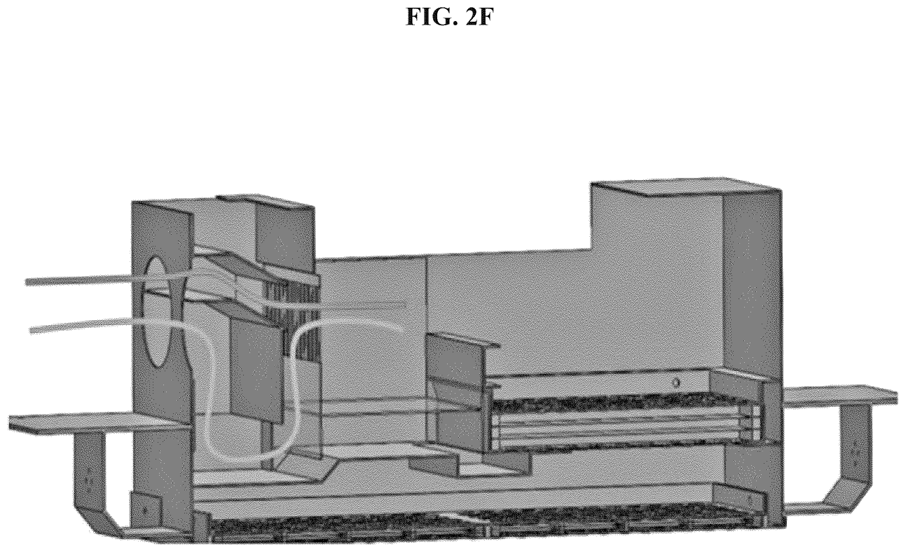

FIG. 2a is a diagram showing another embodiment (second embodiment) of the present invention, which has a somewhat different outer appearance from that of FIGS. 1a to 1h (the first embodiment of the present invention).

The present invention is not limited to the illustration of FIG. 2a, and is presented as an example to explain the overall matters of the apparatus of the present invention.

For reference, the illustrations of FIGS. 2a to 2f may be referred to as a second embodiment of the present invention.

In FIG. 2a, the filtering means 22 is omitted compared to the embodiment of FIGS. 1a to 1h (the first embodiment), and it may be understood that it is omitted only in the illustration so that the impeller 31 is better seen, or, according to necessity, it is also permissible to increase the introduction efficiency by not actually installing the filtering means 22.

In FIG. 2a, at a front upper end part of the impeller 31, a Water splash prevention shield 32 is installed.

FIG. 2b is a partially enlarged view of FIG. 2a.

Although not shown in the drawings, the buoyancy of the hull 10 is adjusted so that the water surface is at an intermediate level of the impeller 31. That is, approximately, above the axis of rotation of the impeller 31 is not submerged in water, and below the axis of rotation will be a state of being submerged in water.

At this time, the impeller 31 introduces contaminated water and sends it toward the storage part 40, and the inflow water may splash out toward the vicinity above the water surface (that is, the upper half of the impeller). To prevent this, a part of an upper end of an inlet side of the pipe 33 (impeller housing) where the impeller 31 is installed is covered by the Water splash prevention shield 32. This shield 32 serves a role of preventing the inflow water, which has been introduced toward the impeller housing 33, from being splashed outward (that is, in the +X direction) by the impeller 31. Through this operation, the efficiency of introducing (retrieving) oil water (contaminated water) can be increased.

That is, as a phenomenon occurs in which water splashes to the front of the hull 10 during rotation of the impeller 31, a problem occurs in that spilled oil is pushed away, and to solve this problem, by coupling the Water splash prevention shield 32 to about 20% to 30% of the upper end of the inlet of the impeller 31, the problem of spilled oil diffusion existing in front of the hull 10 is solved. The 20% to 30% is a preferred example, and if necessary, it may be blocked up to 40% to 50%.

FIG. 2c is a side cross-sectional view near the inlet 20 in the embodiment of FIG. 2a.

In FIG. 2c, the pipe 33 surrounding the impeller 31 is shown, and it can be seen that the inlet 20 and the storage part 40 are connected through this pipe 33. For convenience of explanation, the illustration of the filtering means 22 is omitted.

The impeller 31 is a structure for the introduction (retrieval) of contaminated water, and this may be a thing that operates by being connected to a motor 31M.

The position of the motor 31M shown in FIG. 2c is an example, and other positions are also possible.

The impeller 31 is for introducing (retrieving) contaminated water, and in other words, it may also be explained that it pushes oil on the sea surface downward and sends it rearward. In this case, the closer the impeller 31 is to the retrieval start point, the more quickly the spilled oil on the front part of the hull 10 and the impeller 31 can contact, and the retrieval speed is improved.

That is, when the hull 10 moves forward and retrieves spilled oil (contaminated water), in order to suppress the occurrence of a stagnation phenomenon of the inflow material (that is, seawater+spilled oil) in the impeller housing 33 (pipe), the stagnation phenomenon can be resolved by advancing the position of the impeller 31 and the impeller housing 33 and removing an unnecessary front part.

FIG. 2d is a cross-sectional view of the apparatus of an embodiment of the present invention shown in FIG. 2a, seen from above.

The impeller housing 33 is also shown as a cross-section cut in half, and the impeller 31 is accommodated therein. Although two each of the impeller 31 and the housing 33 are shown, this number may be changed according to necessity, but compared to the case where there is one each of the impeller 31 and the housing 33, the case of having two, as in FIG. 2a, will be better in the efficiency of oil water inflow.

FIG. 2e is a side cross-sectional view showing an interior of the water surface floating layer removal apparatus according to an embodiment of the present invention, and FIG. 2f is a perspective cross-sectional view of the same part.

Going from left to right in FIG. 2e, a flow separation plate 1000, a vertical baffle 2000, and an upper horizontal baffle 4000 exist. A pocket groove 3000 connecting the vertical baffle 2000 and the upper horizontal baffle 4000 is formed.

The vertical baffle 2000, strictly speaking, refers to a wall on the left side in the drawing among the illustrated 2000 (a front wall as the apparatus) and a wall on the right side in the drawing among the illustrated 2000 (a rear wall as the apparatus).

Furthermore, at a lower part of the flow separation plate 1000, the vertical baffle 2000, the pocket groove 3000, and the upper horizontal baffle 4000, a lower horizontal baffle 5000 is formed.

The storage part 40 shown in FIG. la (first embodiment), FIG. 2a (second embodiment), etc., will be understood to correspond approximately to the region indicated by reference numerals 2000, 3000, 4000, and 5000 in FIG. 2e (including the space above reference numeral 4000). Of course, the reference numeral 1000 and the region near it may also be broadly seen as the storage part 40 in the sense that it is the interior of the water surface floating layer removal apparatus of the present invention.

FIG. 2f shows in detail a part schematically shown in FIG. 2e.

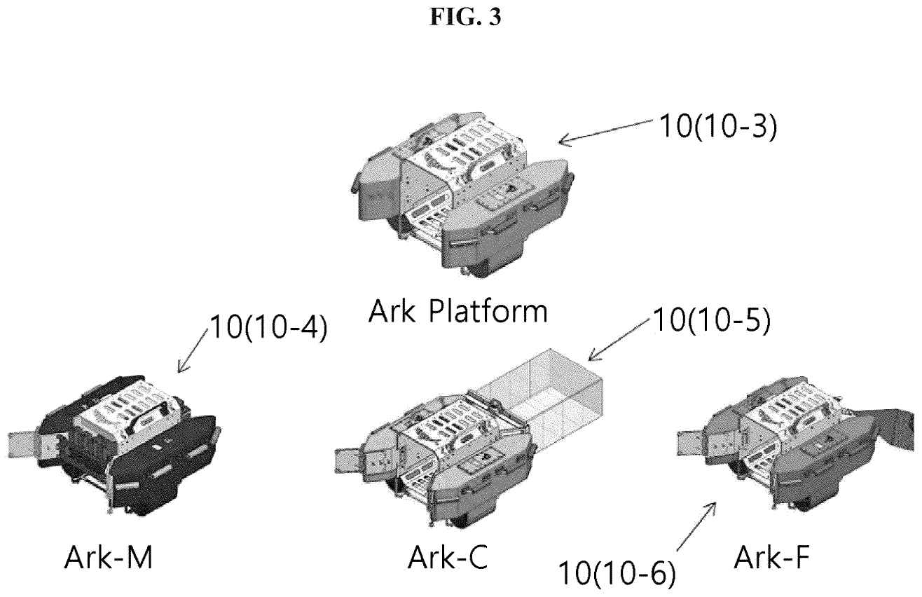

FIG. 3 is a diagram showing other embodiments (Embodiments 3 to 6) of the present invention.

These embodiments (Embodiments 3 to 6) relate to the Ark Platform 10(10-3), the Ark-M 10(10-4), the Ark-C 10(10-5), and the Ark-F 10(10-6) respectively shown in FIG. 3.

The reference numerals for the apparatus 10 of Embodiments 3 to 6 (which may be called by various other names such as hull, oil recovery unit, oil recovery robot, robot, water surface floating layer retrieval apparatus, water surface floating layer removal apparatus, marine contaminant retrieval apparatus, marine debris retrieval apparatus, etc.) are attached as 10(10-3), 10(10-4), 10(10-5), and 10(10-6), respectively, and the meaning is

There is a commonality in that the apparatus 10 of each of these embodiments is the apparatus 10 of the present invention described in FIGS. 1, 2, etc. (that is, various names are possible such as hull, oil recovery unit, oil recovery robot, robot, water surface floating layer retrieval apparatus, water surface floating layer removal apparatus, marine contaminant retrieval apparatus, marine debris retrieval apparatus, etc.),

Individually for each embodiment, there are additionally unique structures and effects of each (slightly modified) embodiment, and therefore, when distinguishing them, they may also be called apparatus 10-3, apparatus 10-4, apparatus 10-5, and apparatus 10-6 is the meaning.

That is, Embodiments 3 to 6 of the present invention, in a broad framework, function as the apparatus 10 (hull, oil recovery unit, oil recovery robot, robot, water surface floating layer retrieval apparatus, water surface floating layer removal apparatus, marine contaminant retrieval apparatus, marine debris retrieval apparatus, etc.), and in detail, it means that the apparatus 10 of Embodiment 3 may have a unique configuration as apparatus 10-3, the apparatus 10 of Embodiment 4 may have a unique configuration as apparatus 10-4, the apparatus 10 of Embodiment 5 may have a unique configuration as apparatus 10-5, and the apparatus 10 of Embodiment 6 may have a unique configuration as apparatus 10-6.

Of course, the term apparatus 10, broadly, is a concept that encompasses Embodiments 1 and 2 as well as Embodiments 3 to 6.

To first briefly explain each embodiment, the Ark Platform 10(10-3) of Embodiment 3—is the most basic Platform Base structure—Various function expansions can be implemented by mounting several sub-modules has the properties.

Next, the Ark-M 10(10-4) of Embodiment 4—is a retrieval solution capable of responding to oil generated from marine accidents—Oil and water can be immediately separated by mounting a main body to which an oil-water separation function is applied inside—The product can be used standalone has the properties.

The Ark-C 10(10-5) of Embodiment 5—is a marine debris retrieval solution that can collect and retrieve small solid contaminants with a net—The net at the lower end part can be simply attached and detached—The product can be used standalone has the properties.

The Ark-F 10(10-6) of Embodiment 6—is a solution that can gather and retrieve a large amount of marine debris by utilizing a net fence—Basically, operation of 2 units of equipment is necessary—Can process floating marine debris together with a large-scale cleaning vessel has the properties.

To explain Embodiments 3 to 6 comprehensively,

Whereas Embodiment 1 or Embodiment 2 has a fixed single form with not much room for change in outer appearance,

Embodiments 3 to 6 are ones in which the functional module for oil recovery is completely separable,

For example, if a certain member (module) is attached to or detached from the apparatus of Embodiment 3, it becomes Embodiment 4, and likewise, if another member (module) is attached to or detached from the apparatus of Embodiment 3, it becomes Embodiment 5, and likewise, if yet another member (module) is attached to or detached from the apparatus of Embodiment 3, it becomes Embodiment 6.

And, although there are of course parts where the detailed outer appearance is different, some functions are different, and the position and number of each member are different, basically, each member shown in Embodiments 1 to 2 (for example, the inlet 20, the impellers 30-1 to 30-4 (Propulsion bodies), the storage part 40) is also provided in Embodiments 3 to 6.

Hereinafter, the details thereof will be described.

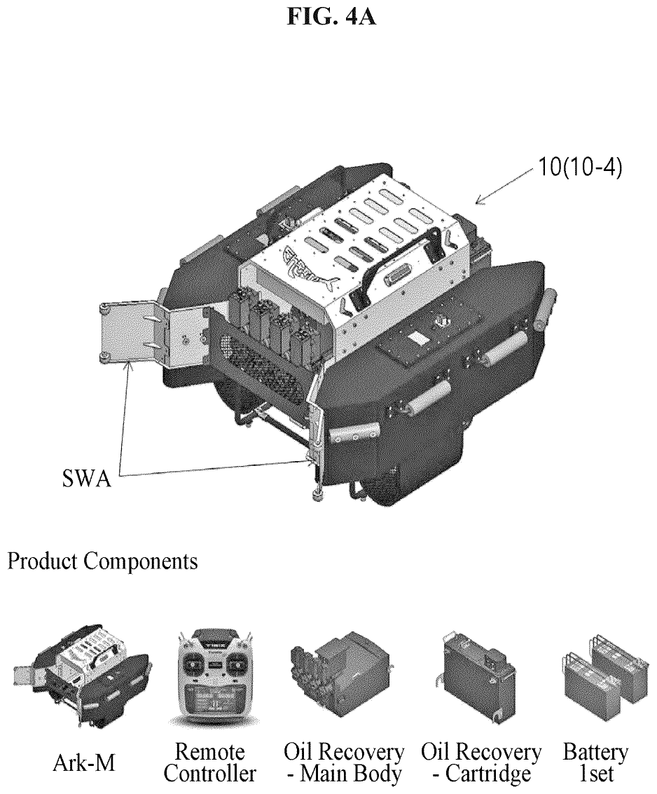

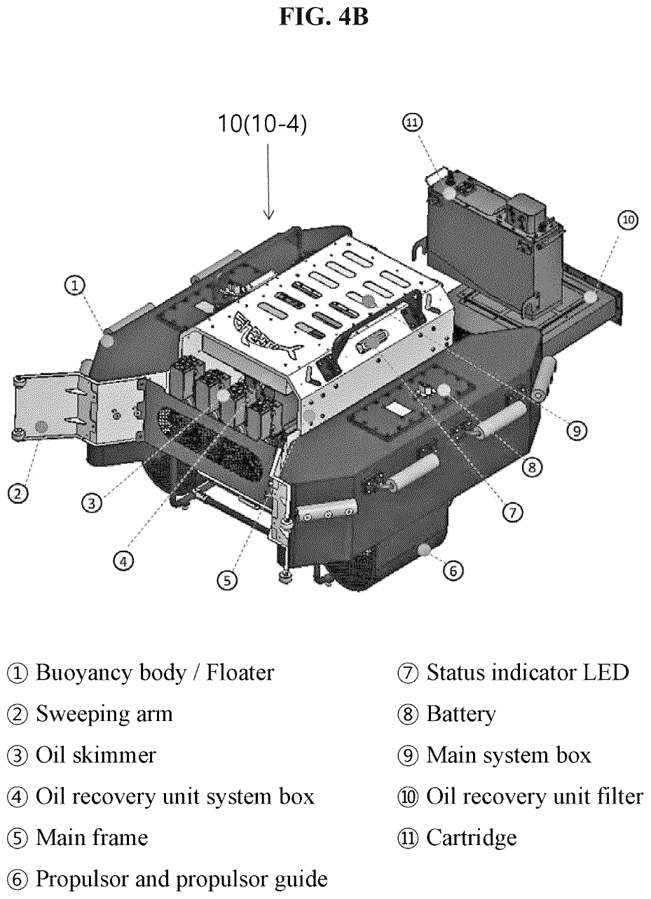

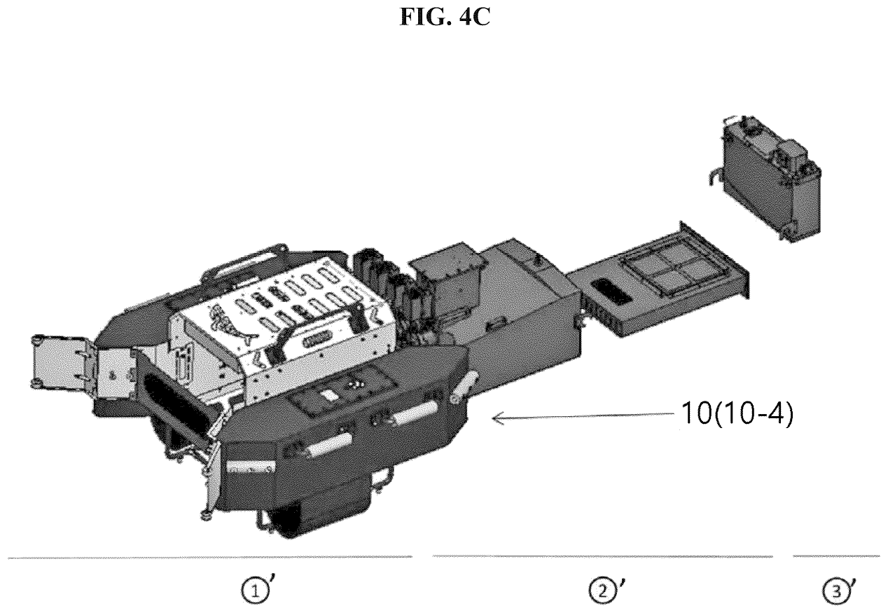

FIG. 4a is a diagram showing the apparatus 10-4 of Embodiment 4 of the present invention.

The apparatus 10-4 (oil recovery robot) comprises parts as shown in FIG. 4a, and,
a sweeping arm (SWA) is attached at a front of the robot 10-4 to improve contaminant collection and retrieval capability,
the cartridge (oil recovery cartridge) is capable of being disassembled and assembled through a hook and a snatch lock located at a rear of the product,
two batteries are basically mounted in the product as 1 set,
the controller (wireless controller), for example, can be implemented using a 16IZ model of a Futaba product.

For reference, ‘cartridge’ is a module corresponding to the storage part 40 aforementioned in Embodiments 1 and 2, and it may also be understood that the cartridge is a somewhat modified version of the storage part 40 of Embodiments 1 and 2 to be detachable. However, the storage part 40 of Embodiments 1 and 2, although not limited thereto, is typically assumed to be fixed to the hull 10, and the cartridge of Embodiment 4 is detachable, so there is a difference. Furthermore, if one must state a difference, it is highly likely that oil water (that is, oil and water) is stored together in the storage part 40 of Embodiments 1 and 2, but in the cartridge of Embodiment 4, it is highly likely that preferably oil (after being separated from water) is mainly stored. Of course, although the position or detachability of the cartridge of Embodiment 4 is different from the storage part 40 of Embodiments 1 and 2, it has a somewhat common function in that it stores oil water (and/or marine contaminants).

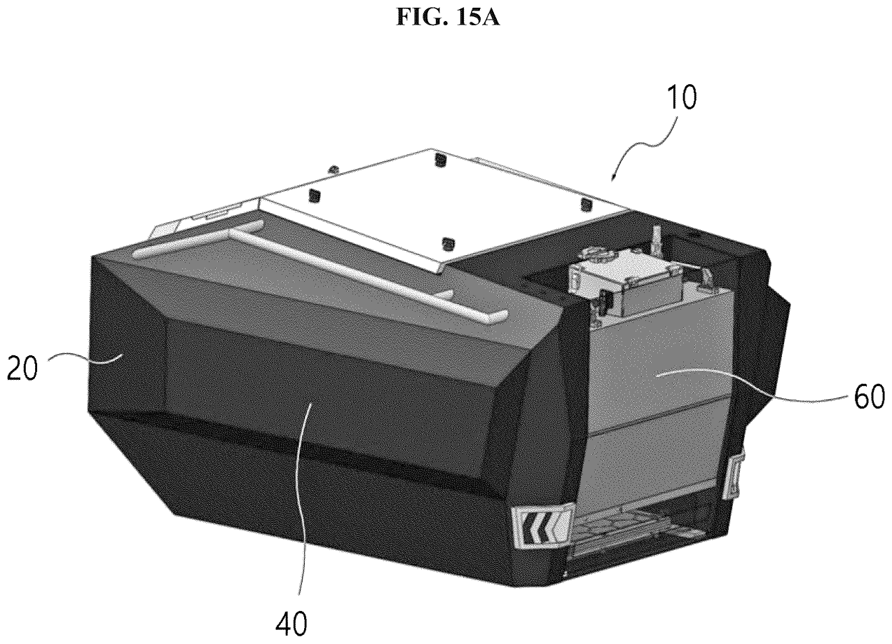

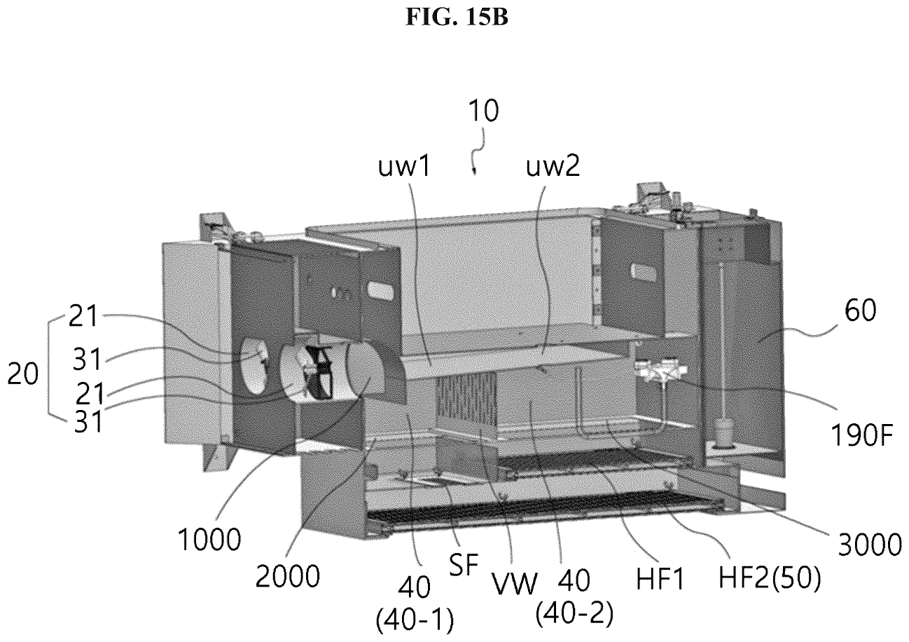

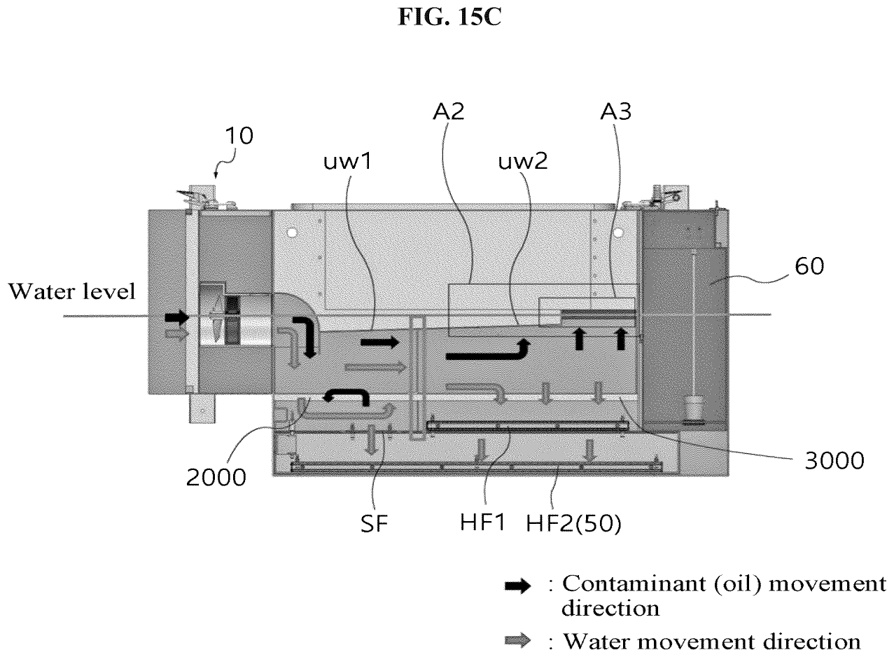

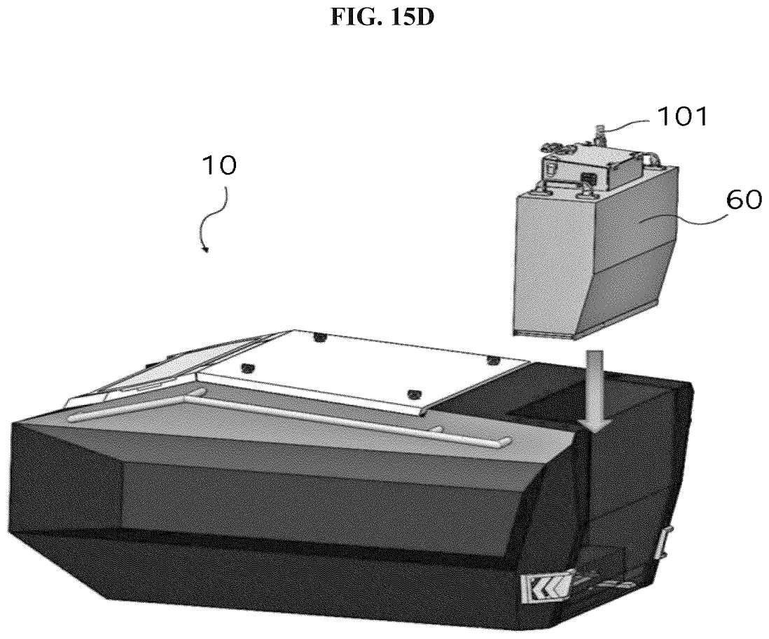

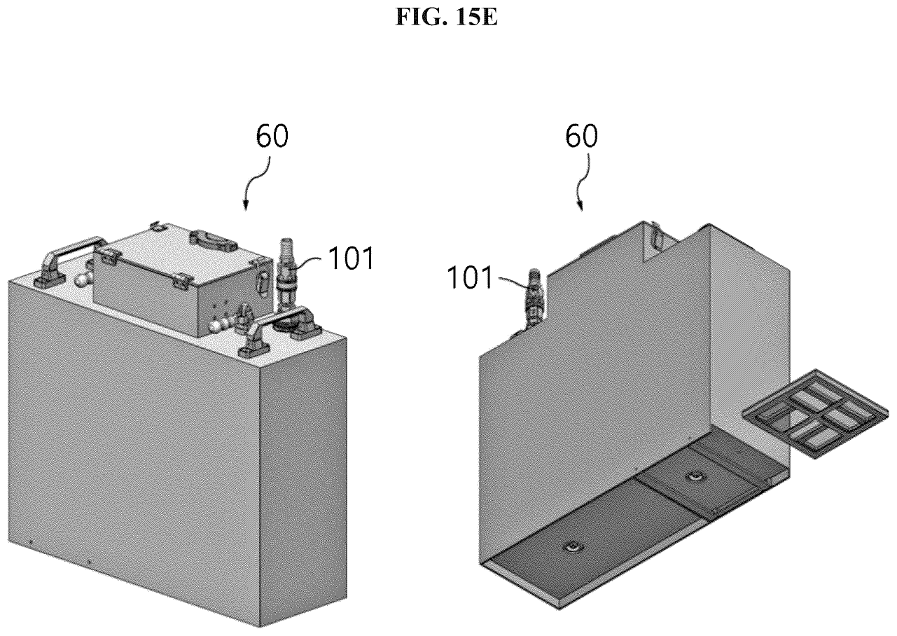

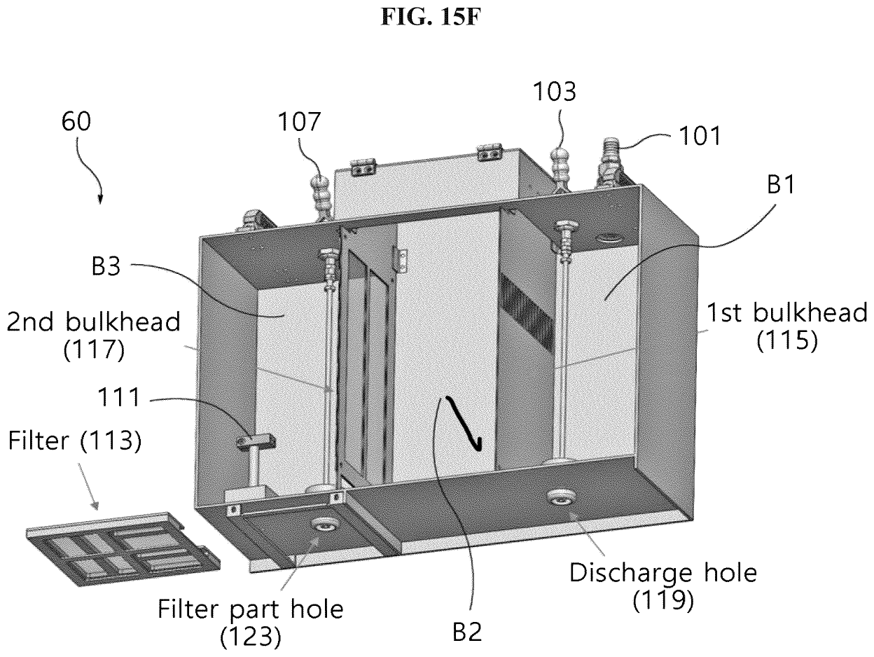

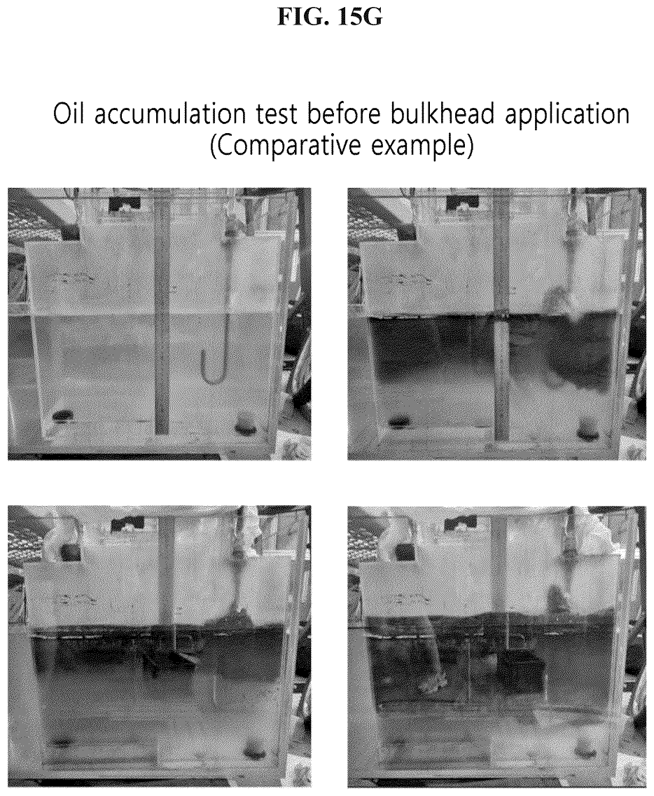

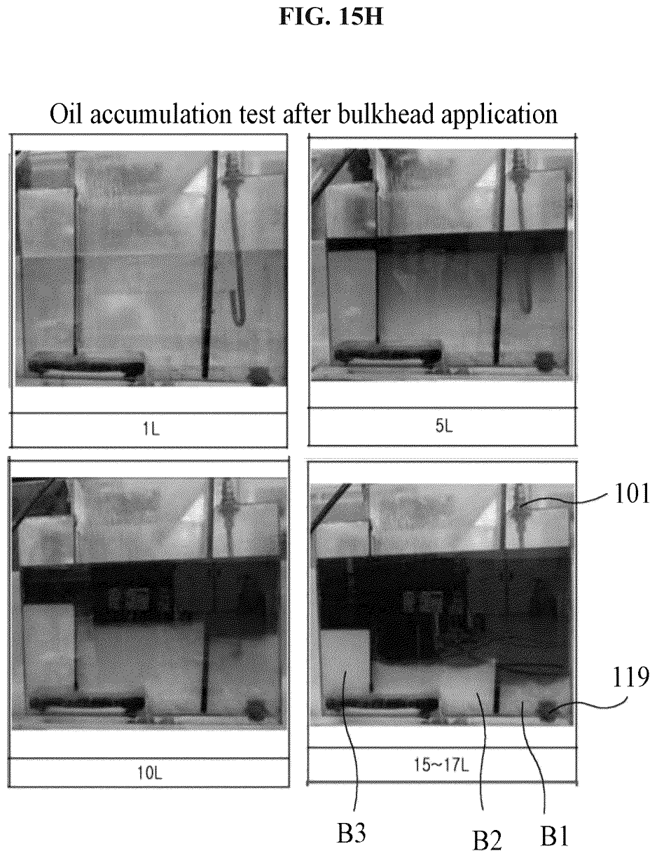

Furthermore, as will be described later, the cartridge of Embodiment 4 may be replaced (to the extent possible based on its properties) with the cartridge 60 of Embodiment 7 shown in FIGS. 15a to 15h.

FIG. 4b is a diagram for explaining the apparatus 10-4 of Embodiment 4 of the present invention by part.

The apparatus 10-4 (which may be called by other names such as oil recovery unit, oil recovery robot, robot, marine contaminant retrieval unit, marine debris retrieval unit, etc.), as shown in FIG. 4b, has each component from \textcircled{1} Buoyant body to \textcircled{11} Cartridge.

‘Sweeping arm (SWA)’ and ‘cartridge’ have also been mentioned in the description of FIG. 4a.

IG. 4c is an exploded perspective view of FIG. 4b

Regarding \textcircled{1}, this is an exterior part, and includes storage for the main system components of the product, the Propulsion body, and the Buoyant body. The battery can be replaced inside by opening the exterior lid on top of the Buoyant body, and battery charging is possible using the connector on top of the Buoyant body.

Regarding \textcircled{2}, this is a recovery part, and is an apparatus for retrieving contaminants, in which a motor and an impeller necessary for rotational power are built-in, and it serves a role of floating the contaminated oil above the water surface and discharging clean water out of the equipment through the built-in filter.

Regarding \textcircled{3}, this is a cartridge part, is located at a rear of the recovery part, and serves a role of storing the retrieved contaminants. The contaminants can be easily discharged by operating a manual valve on top of the cartridge.

To explain in more detail,
in FIG. 4a, the apparatus 10 is in a state of being fully assembled,
in FIG. 4b, part \textcircled{3} (oil recovery part) is shown as it is assembled, and only part \textcircled{10} (oil recovery part filter) and part \textcircled{11} (cartridge) are shown virtually disassembled and slightly rearward,
and in FIG. 4c, part \textcircled{3} (oil recovery part), part \textcircled{10} (oil recovery part filter), and part \textcircled{11} (cartridge) are all shown virtually disassembled and pushed back a considerable portion to the rear.

That is, in actuality, the apparatus 10 is launched and operates as shown in FIG. 4a, and according to necessity, contaminated water is introduced into part \textcircled{3} (oil recovery part) while in ‘a state with the sweeping arm (SWA) open’ or ‘while the sweeping arm (SWA) repeats opening and closing’.

When contaminated water is introduced into part \textcircled{3} (oil recovery part), oil is separated upward and water is separated downward due to a density difference, and at this time, by part \textcircled{10} (oil recovery part filter) located at a lower part thereof, water is approximately separated to a lower part (inside) of part \textcircled{10} (oil recovery part filter), and oil does not pass through part \textcircled{10} (oil recovery part filter) (for example, a mesh) and remains on top of part \textcircled{10} (oil recovery part filter).

And, part \textcircled{11} (cartridge) is located at a rear of part \textcircled{3} (oil recovery part) and at an upper part of part \textcircled{10} (oil recovery part filter), and it is good to have the retrieved contaminants (for example, separated oil) be retrieved into part \textcircled{11} (cartridge).

According to the oil recovery robot 10-4 of the fourth embodiment of the present invention as such, it is possible to check current data of actuators such as the robot's Propulsion body, the recovery part for contaminant retrieval, and the electric opening and closing device of the cartridge, and rotation data through a sensor, so state analysis and alarm are possible when an error occurs.

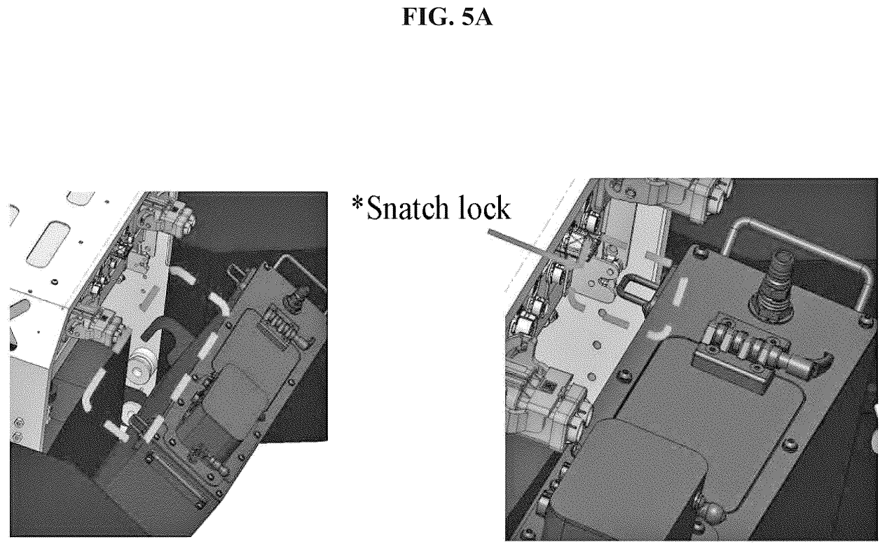

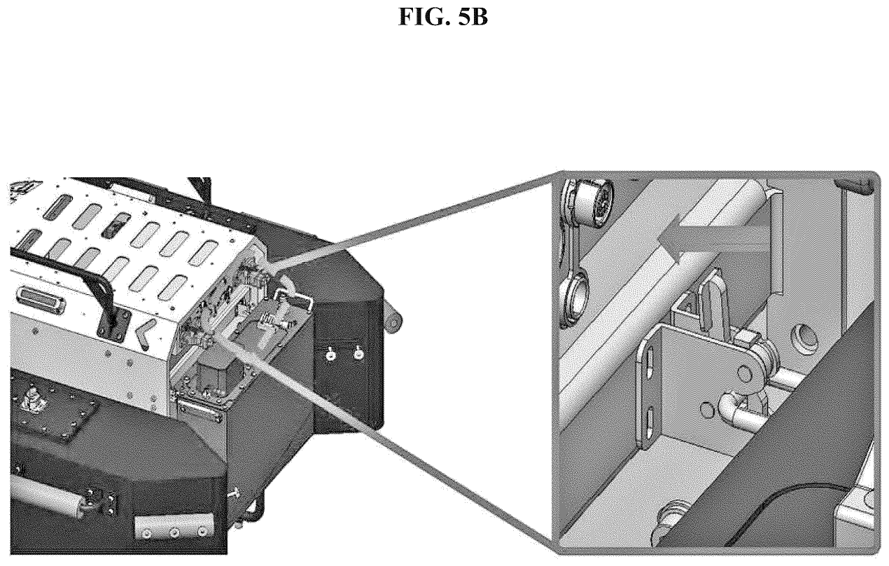

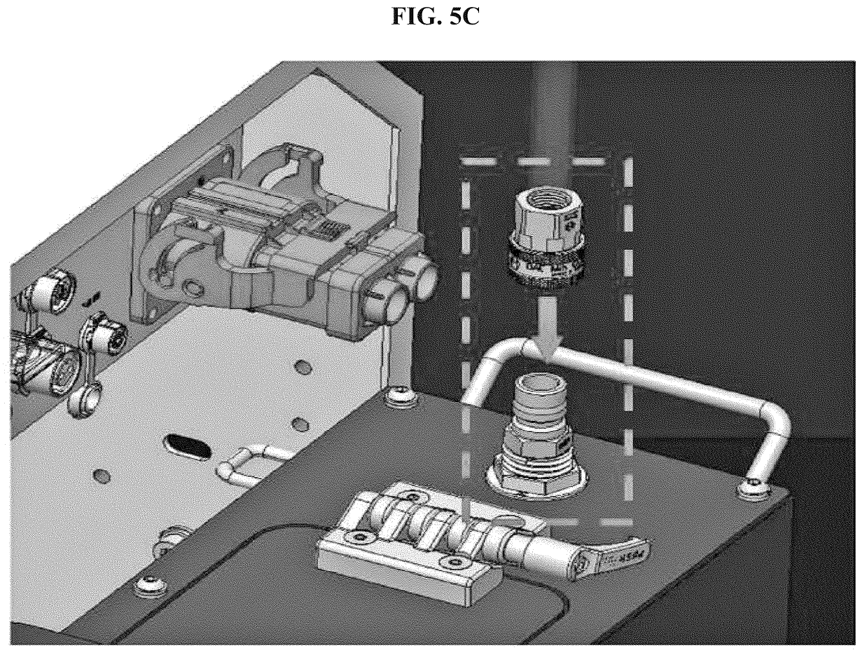

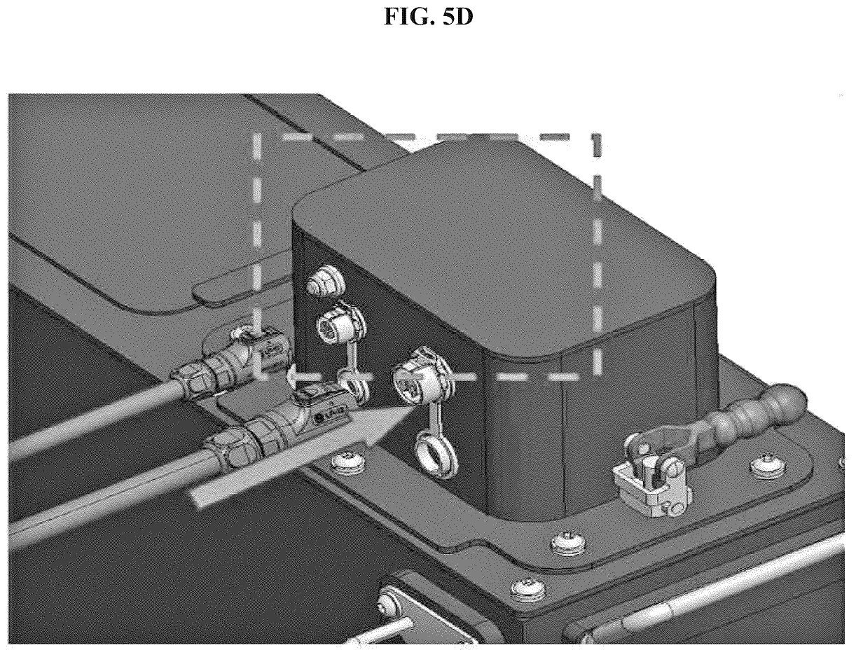

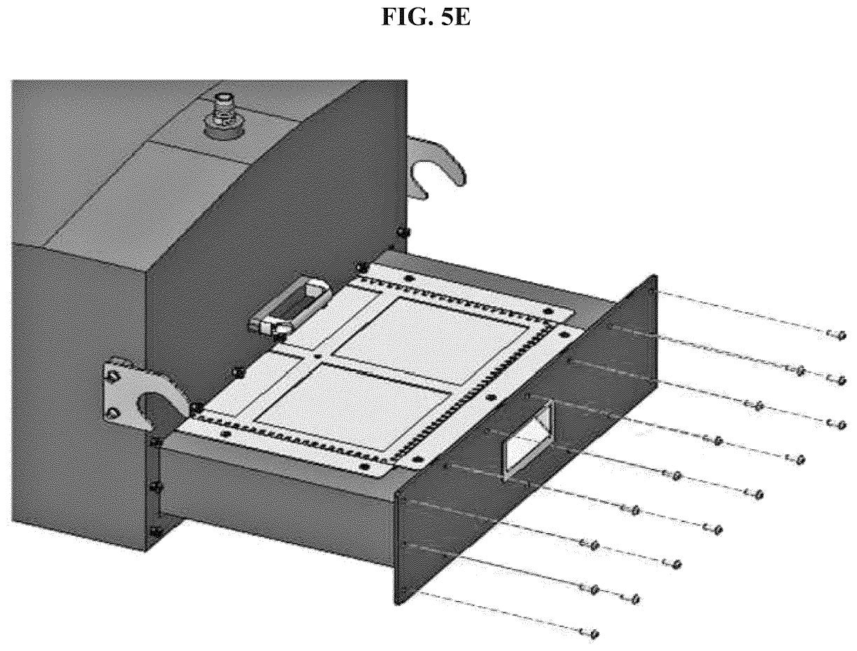

FIGS. 5a to 5e are diagrams explaining the assembly and disassembly of the cartridge part before the deployment of the equipment 10-4.

The Ark-M (that is, the oil recovery robot 10-4) enables contaminant retrieval with simple assembly. Foreign substances and oil can be separated through a filter, and oil can be collected in the cartridge through oil retrieval utilizing an oil extraction system.

In FIG. 5a, a hook at a lower part of the cartridge is hung on a hook located at a rear of the product. Thereafter, an upper part of the cartridge is pushed toward the product to be automatically locked by a snatch lock.

In FIG. 5b, in the case of disassembly, a lever of the snatch lock is pushed to release the lock, and it is disassembled.

In FIG. 5c, after the cartridge is coupled, a hose is coupled to an upper part of the cartridge.

In FIG. 5d, cables are coupled to two places on a valve module at the upper part of the cartridge.

In FIG. 5e, a filter module at a lower end of the oil recovery part is coupled.

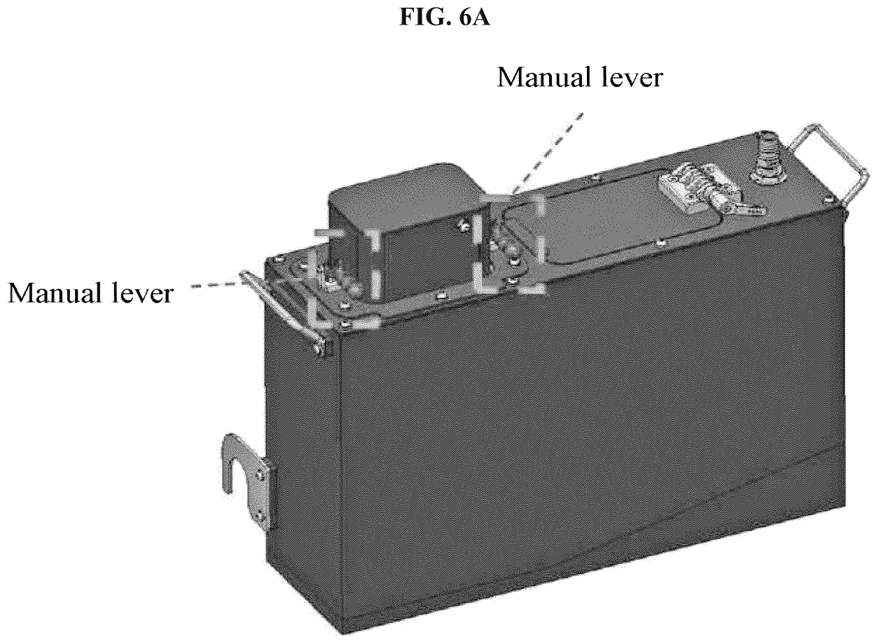

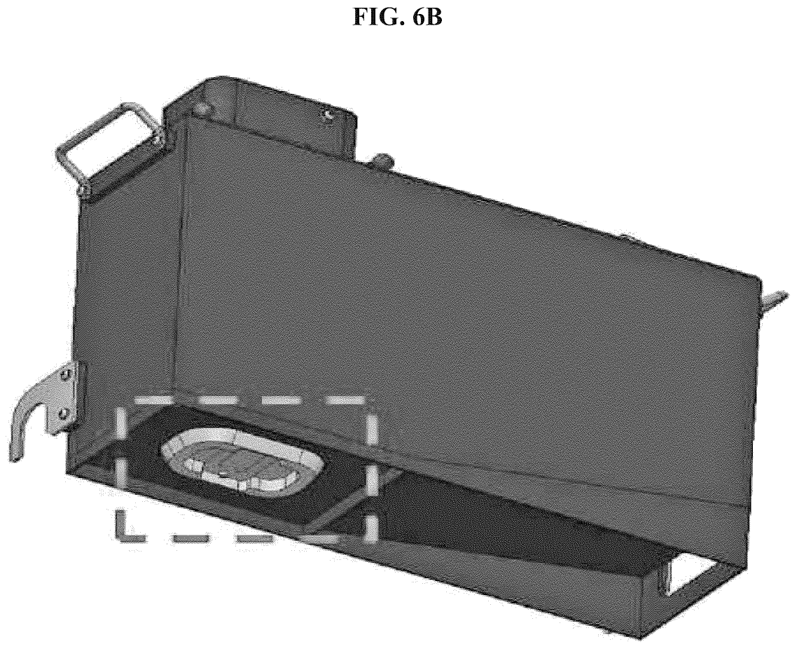

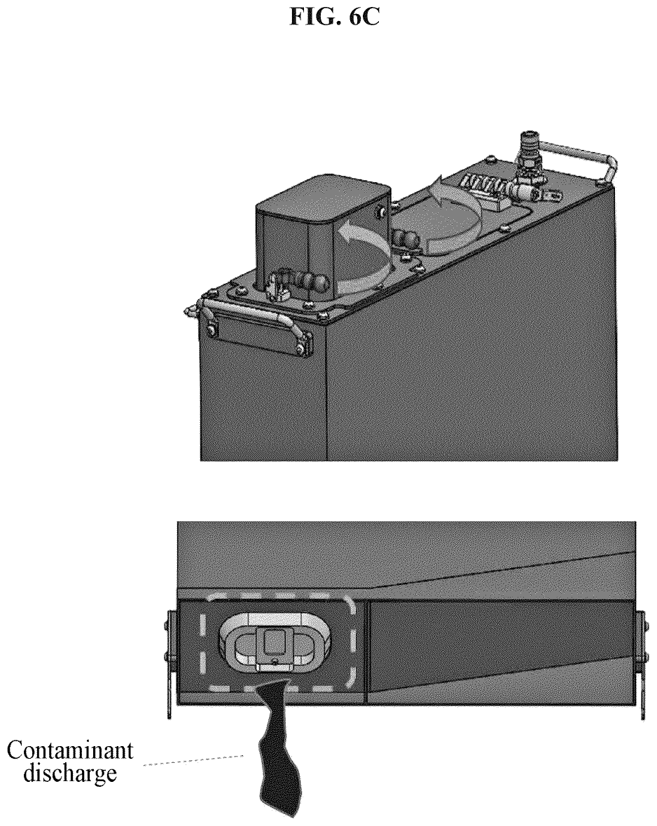

FIGS. 6a to 6c are diagrams explaining a method of using the cartridge.

In FIG. 6a, there is an opening and closing lever of a manual valve on a left side of the cartridge.

In FIG. 6b, a lower end of the manual lever directly communicates with the outside and serves a role of discharging contaminants filled inside.

In FIG. 6c, when deploying the equipment 10-4 to a contaminated area, it is good to surely lock the manual lever, and it is deployed into the water after opening the electric lever through operation of the remote control (controller, wireless controller).

After the work is finished, after closing the electric lever using the controller, retrieval of the equipment 10-4 is proceeded with.

After separating the cartridge from the equipment, oil is discarded by simultaneously raising the manual lever.

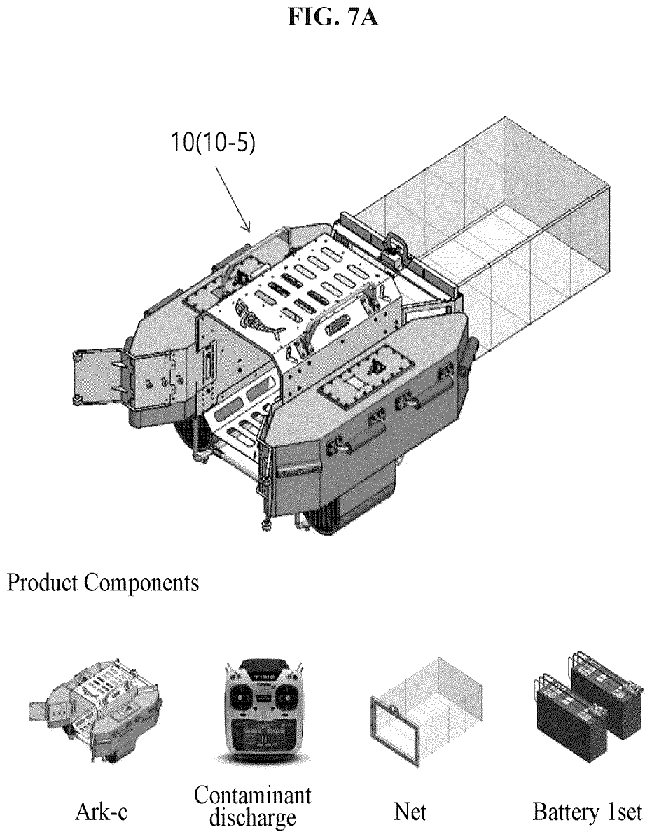

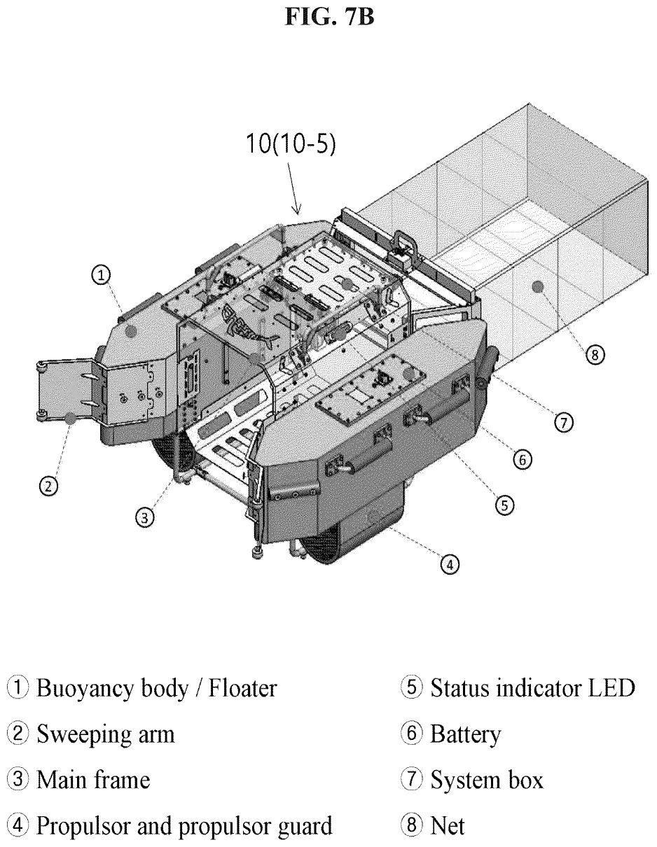

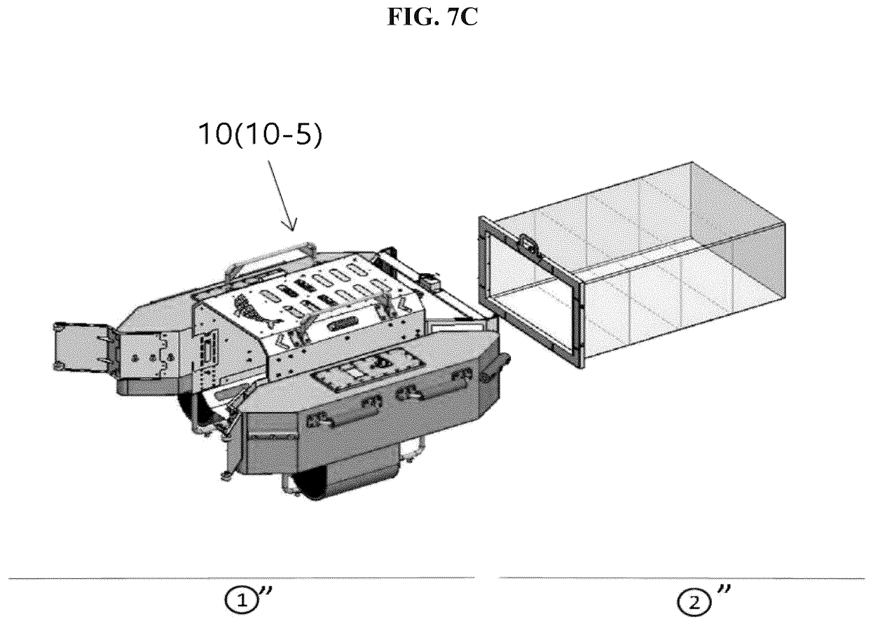

FIG. 7a is a diagram showing the apparatus 10-5 of Embodiment 5 of the present invention.

The apparatus 10-5 (oil recovery robot) comprises parts as shown in FIG. 7a, and,

For example, the net has a basic capacity of 500 L, and is capable of being disassembled and assembled using a toggle latch on an upper part of the product,
two batteries are basically mounted in the product as 1 set,
the controller (wireless controller, remote control), for example, can use a 16IZ model of a Futaba product.

FIG. 7b is a diagram for explaining the apparatus 10-5 of Embodiment 5 of the present invention by part.

The apparatus 10-5 (which may be called by other names such as oil recovery unit, oil recovery robot, robot, marine contaminant retrieval unit, marine debris retrieval unit, etc.), as shown in FIG. 7b, has each component from \textcircled{1} Buoyant body to \textcircled{8} net.

FIG. 7c is an exploded perspective view of FIG. 7b.

Regarding \textcircled{1}″, this is an exterior part, and includes storage for the main system components of the product, the Propulsion body, and the Buoyant body. The battery can be replaced inside by opening the exterior lid on top of the Buoyant body, and battery charging is possible using the connector on top of the Buoyant body.

Regarding \textcircled{2}″, this is a net part, is coupled to a rear of the exterior part, and serves a role of storing the retrieved waste. The waste can be easily discharged using a drawstring at a rear of the net, and it can be easily disassembled and assembled using a toggle latch on top of the frame.

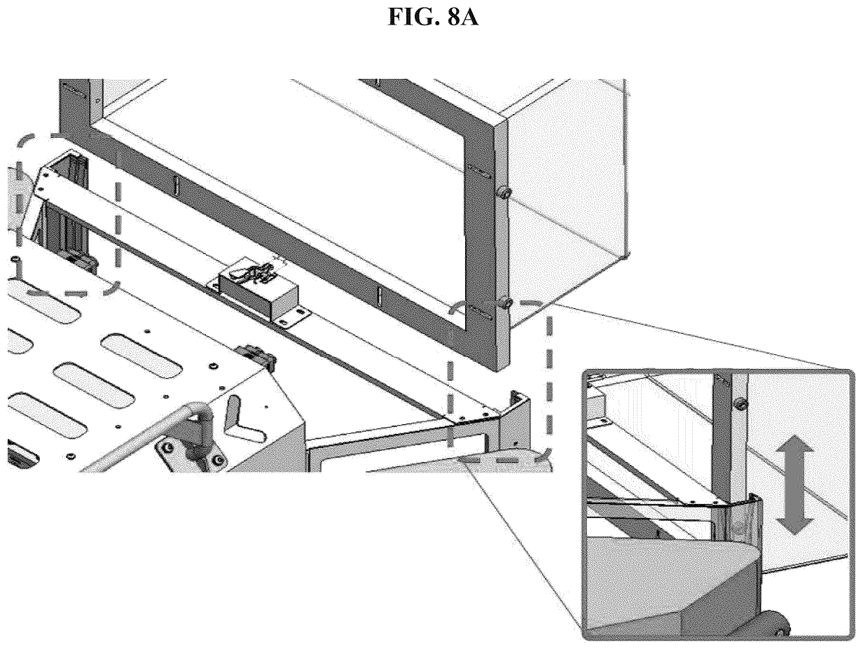

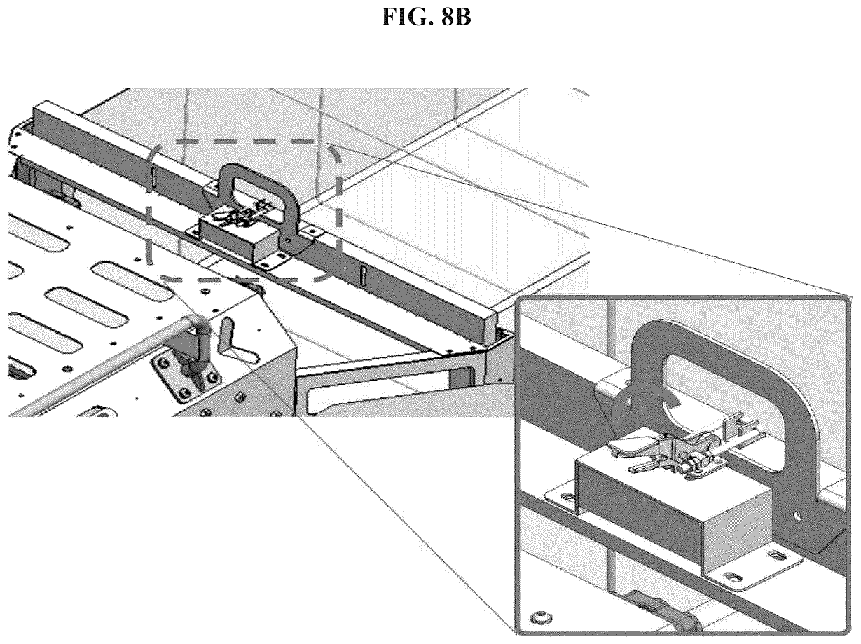

FIGS. 8a and 8b are diagrams explaining the assembly and disassembly of the net before the deployment of the equipment 10-5.

The Ark-C (that is, the oil recovery robot 10-5) is a robot that retrieves waste through a net that is simply detachable. A user can move the robot 10-5 to a place where waste is located, and thereafter, can collect it in the net by passing the robot 10-5 between the waste. When the waste collection is completed, the waste can be easily removed by loosening the drawstring at the rear of the net.

In FIG. 8a, the net is inserted through a groove at a rear of the product.

In FIG. 8b, after inserting the net, it is fixed so as not to detach by fastening the toggle latch.

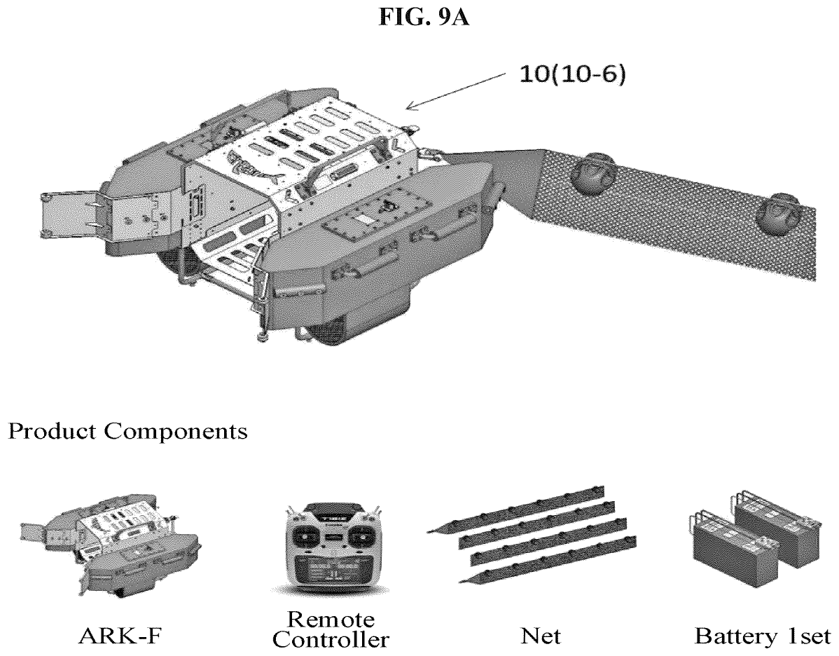

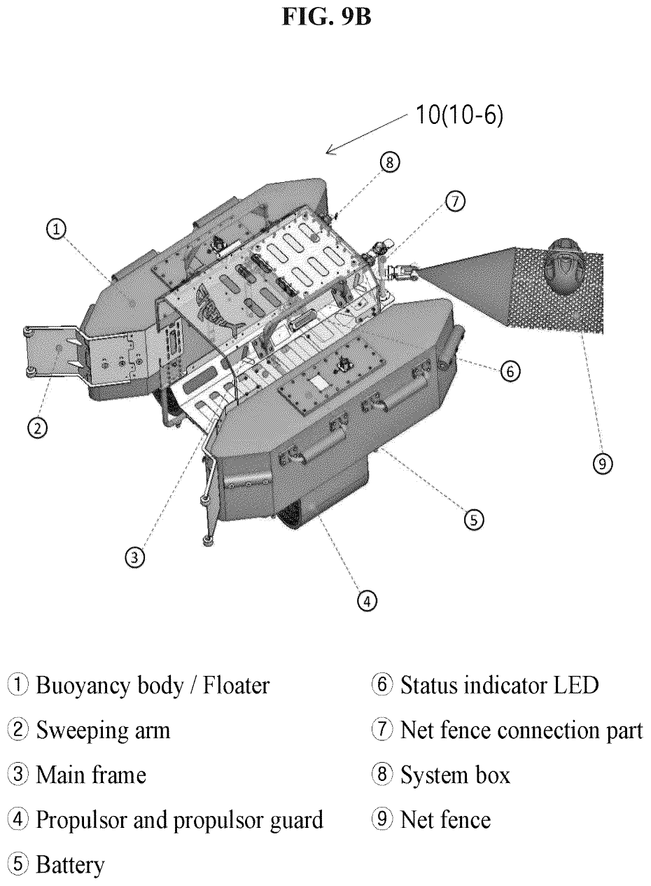

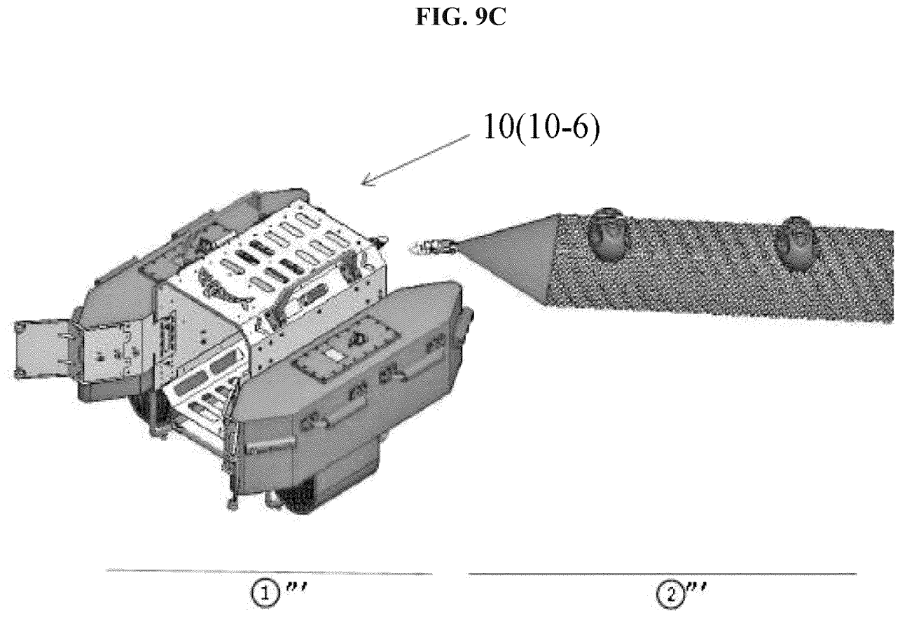

FIG. 9a is a diagram showing the apparatus 10-6 of Embodiment 6 of the present invention.

The apparatus 10-6 (oil recovery robot) comprises parts as shown in FIG. 9a, and,
the net fence is 1 set of 4 total in 5 m units, and is a structure that can be mutually coupled, and can be used up to 20 m according to the situation,
two batteries are basically mounted in the product as 1 set,
the controller (wireless controller, remote control), for example, uses a 16IZ model of a Futaba product.

FIG. 9b is a diagram for explaining the apparatus 10-6 of Embodiment 6 of the present invention by part.

The apparatus 10-6 (which may be called by other names such as oil recovery unit, oil recovery robot, robot, marine contaminant retrieval unit, marine debris retrieval unit, etc.), as shown in FIG. 9b, has each component from \textcircled{1} Buoyant body to \textcircled{9} net fence.

FIG. 9c is an exploded perspective view of FIG. 9b.

Regarding \textcircled{1}″, this is an exterior part, and includes storage for the main system components of the product, the Propulsion body, and the Buoyant body. The battery can be replaced inside by opening the exterior lid on top of the Buoyant body, and battery charging is possible using the connector on top of the Buoyant body.

Regarding \textcircled{2}″, this is a net fence part, is coupled to a rear of the exterior part, and serves a role of gathering and moving waste. Assembly and disassembly of each net fence are possible using a carabiner at an end of the net fence, and coupling to the product is also possible.

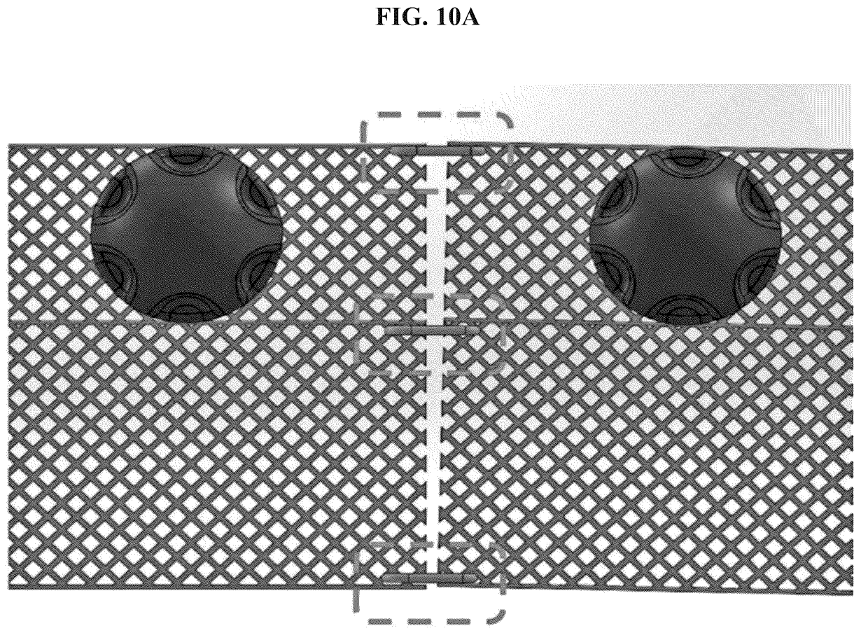

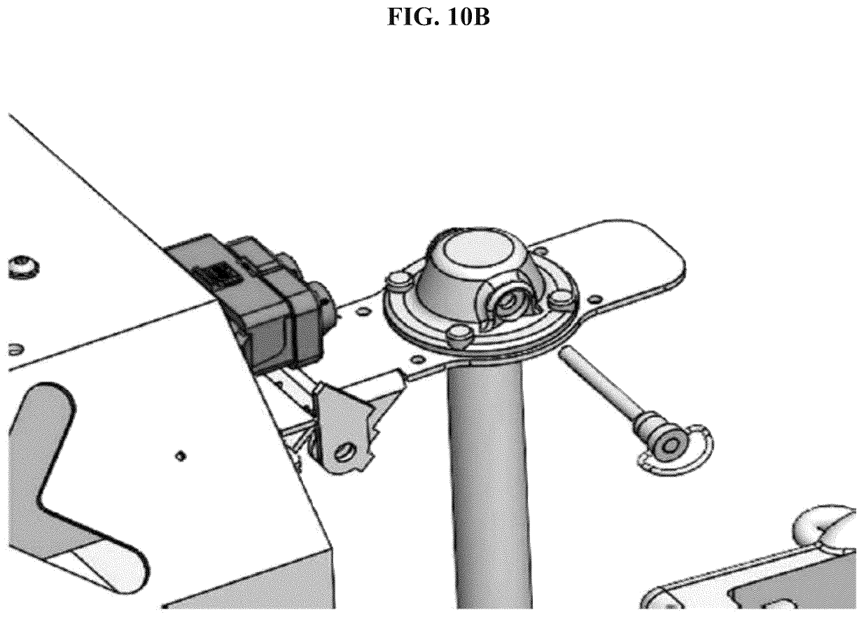

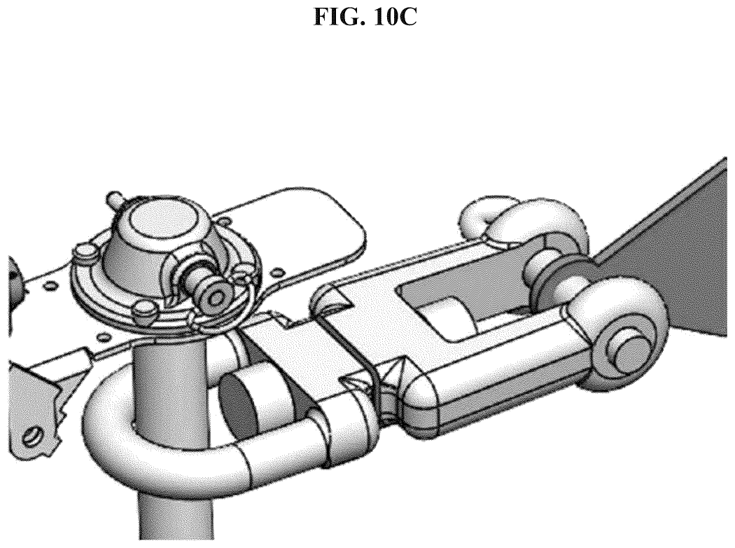

FIGS. 10a to 10c are diagrams explaining the assembly and disassembly of the net fence before the deployment of the equipment 10-6.

The ARK-F (that is, the oil recovery robot 10-6) enables waste retrieval with simple assembly. Two units (that is, 2 oil recovery robots 10-6) are operated simultaneously, and they connect a net fence to the rear of each product to collect and deliver the waste to a cleaning vessel to process the waste.

In FIG. 10a, the length is set according to the purpose, and the net fences are connected to each other using carabiners at both ends of the net fences by the required quantity.

In FIG. 10b, a stop pin at a rear of the product is removed, and a pipe cap is lifted up.

In FIG. 10c, a tripod is coupled to the net fence connecting pipe. Thereafter, the stop pin is coupled.

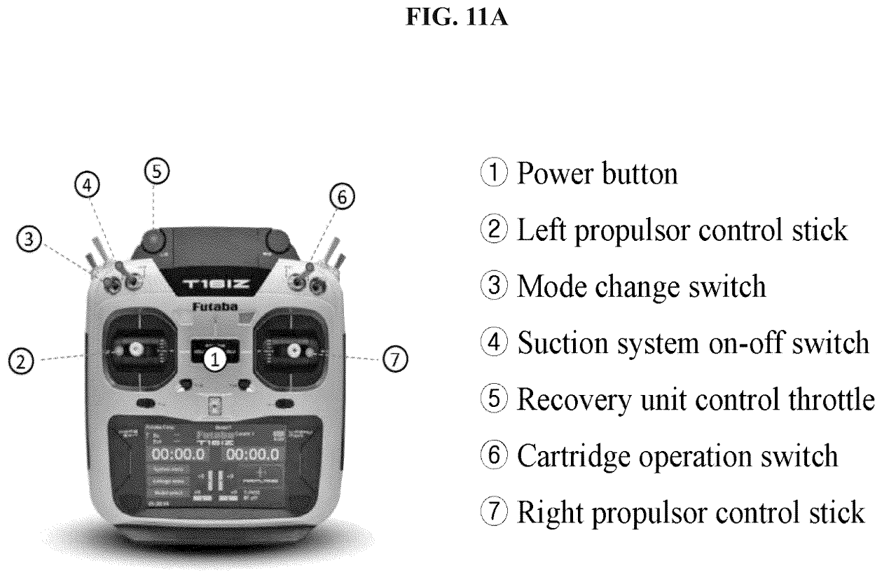

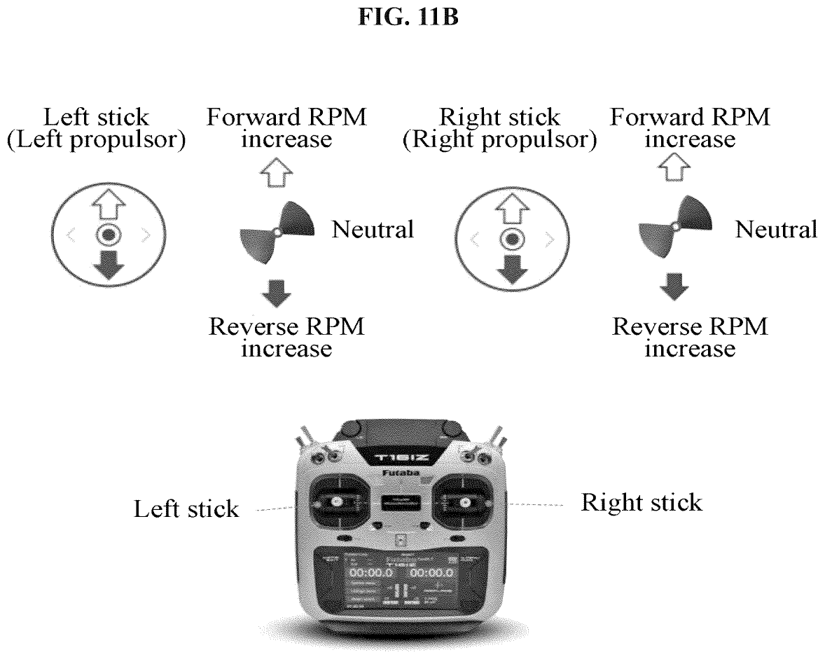

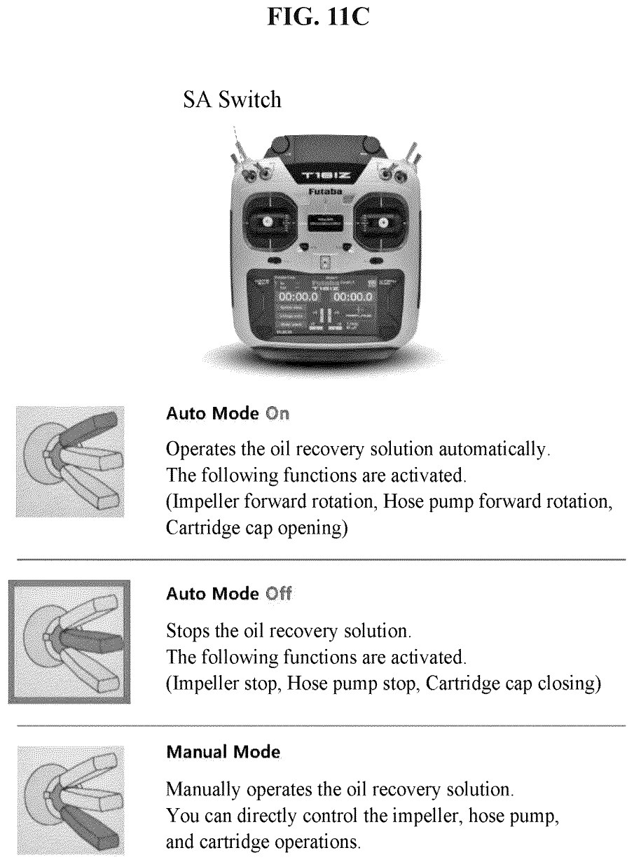

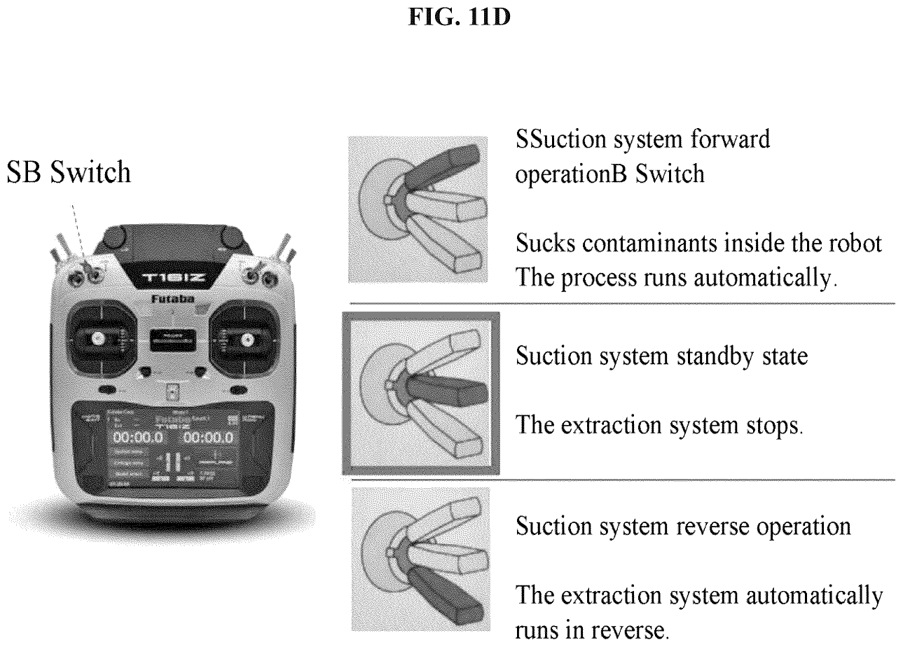

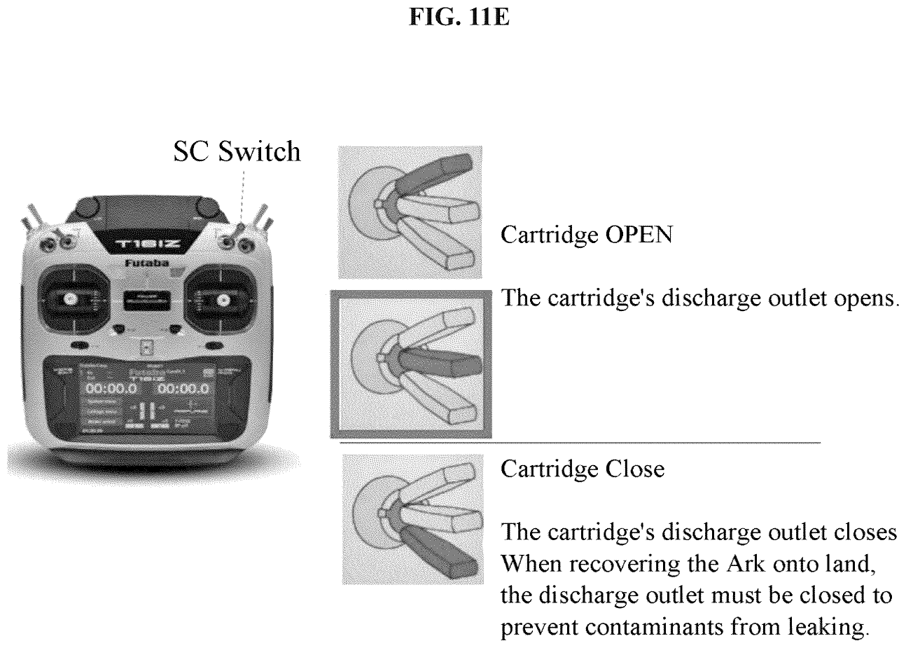

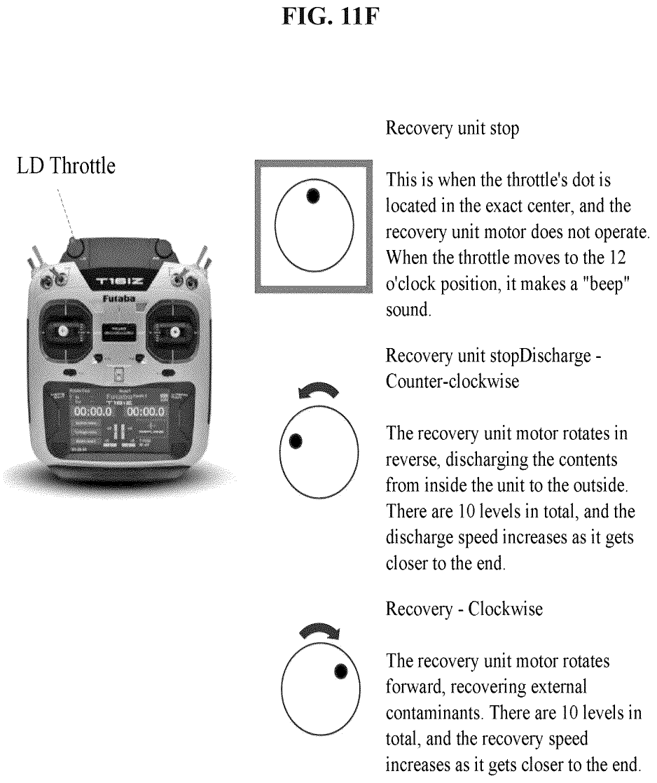

FIG. 11a is a diagram for explaining a controller (wireless controller, remote control).

Although it is not limited to this, for example, the controller used in the Sheco Ark (the oil recovery robots 10-3, 10-4, 10-5, 10-6 of Embodiments 3 to 6) uses the T16IZ product from Futaba. The battery capacity of the controller is 14.8 Wh (7.4 VDC-2000 mAh), and it can be used for 8 hours or more.

Descriptions of \textcircled{1} to \textcircled{7} shown in FIG. 11 a are as follows. Although described from the perspective of the controller, since the controller ultimately operates the oil recovery robots 10-3 to 10-6, it will be understood that they are configurations and functions provided in the oil recovery robots 10-3 to 10-6.
\textcircled{1} Power Button

When the power button is pressed, the controller turns on. Powering off is terminated when the power button is pressed for about 2 seconds while the power is on.
\textcircled{2} Left Propulsion body control stick

It is in charge of left Propulsion body control of the Ark 10-3 to 10-6. Pushing up is forward, and pulling down is backward. This control stick operates independently of the ‘right Propulsion body control stick’.
\textcircled{3} Mode change switch

A total of 3 mode change functions exist. When the controller is held normally, pushing up activates the oil recovery function Auto Mode, the middle stops the oil recovery function Auto Mode, and pulling down becomes the manual mode state. Functions \textcircled{5}, \textcircled{6}, and \textcircled{7} can be operated when in the manual mode state.
\textcircled{4} Suction system on-off switch

A total of 3 extraction system functions exist. When the controller is held normally, pushing up activates suction so that contaminants are introduced into the cartridge, the middle position stops operation, and pulling down rotates in a reverse direction to move contaminants from the cartridge to the robot.
\textcircled{5} Recovery part control throttle

It is a throttle that can control the operation direction and retrieval speed of the recovery part. The dot of the throttle is the reference for the position. Based on the very center (stop), it can be adjusted in 10 steps in each of both directions, and performs a discharge operation when rotated counterclockwise and a retrieval operation when rotated clockwise. The more the throttle is rotated toward the end of each direction, the faster the retrieval and discharge speed becomes.
\textcircled{6} Cartridge opening and closing switch

It is a switch in charge of the opening and closing function of the cartridge, and a total of 2 functions exist. When the controller is held normally, when the stick position is up, it is cartridge opening, when the stick is in the middle, it is stop, and when it is down, it is cartridge closing.
\textcircled{7} Right Propulsion body control stick

It is in charge of right Propulsion body control of the Ark (the oil recovery robots 10-3 to 10-6). Pushing up is forward, and pulling down is backward. This control stick operates independently of the ‘left Propulsion body control stick’.

FIGS. 11b to 11f also show explanations regarding the controller.

As described above, since the controller ultimately operates the oil recovery robots 10-3 to 10-6, it will be understood that they are configurations and functions provided in the oil recovery robots 10-3 to 10-6.

Regarding FIG. 11b, from the perspective of body (hull) (that is, the oil recovery robots 10-3 to 10-6) operation control, the direction and speed of propulsion, and the forward/backward, clockwise/counterclockwise rotation of the body can be controlled using the two control sticks of the controller. The left stick is in charge of the output of the Propulsion body located on the left side of the equipment, and the right stick is in charge of the output of the Propulsion body located on the right side of the equipment.

Regarding FIG. 11c, from the perspective of a mode change system, an operation method for simply operating the contaminant retrieval solution is shown.

The details thereof are divided into (i) Auto Mode On, (ii) Auto Mode Off, and (iii) Manual Mode, as shown in FIG. 11c.

In (i) Auto Mode On,
the oil recovery solution is proceeded with automatically,
and it operates with impeller forward rotation, hose pump forward rotation, and cartridge plug opening.

In (ii) Auto Mode Off,
the oil recovery solution is stopped,
and it operates with impeller stop, hose pump stop, and cartridge plug closing.

In (iii) Manual Mode,
the oil recovery solution is manually operated,
and the impeller, hose pump, and cartridge operations can be directly utilized.

Regarding FIGS. 11d to 11f, additional function control of the body (hull) is possible.

This additional function includes, for example, cartridge opening and closing, extraction system on-off, and recovery part control.

FIG. 11d is a diagram regarding the suction system on/off, and it can operate in 3 modes shown in FIG. 11d according to the switch position.

FIG. 11e is a diagram regarding cartridge opening and closing, and it can operate in 2 modes shown in FIG. 11e according to the switch position.

FIG. 11f is a diagram regarding recovery part control, and it can operate in 3 modes shown in FIG. 11f according to the switch position.

Regarding FIGS. 11a to 11f,

In almost all situations for contaminant retrieval work, the cartridge lever is Opened to enable internal buoyancy control during equipment deployment and smooth clean water discharge after oil-water separation work,

However, when retrieving the equipment, it is preferable to proceed with the retrieval work after surely Closing [it] in order to prevent contaminants inside the cartridge from escaping to the outside.

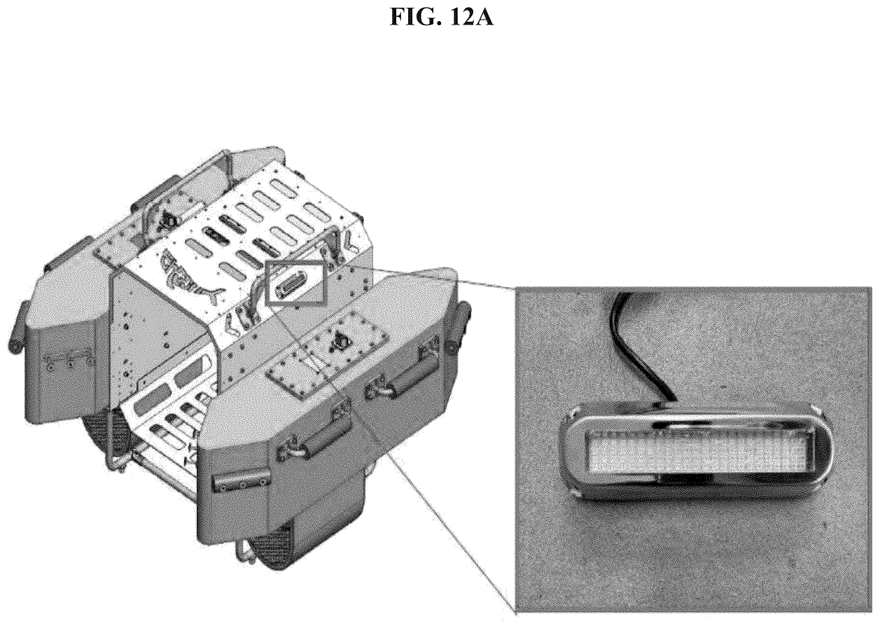

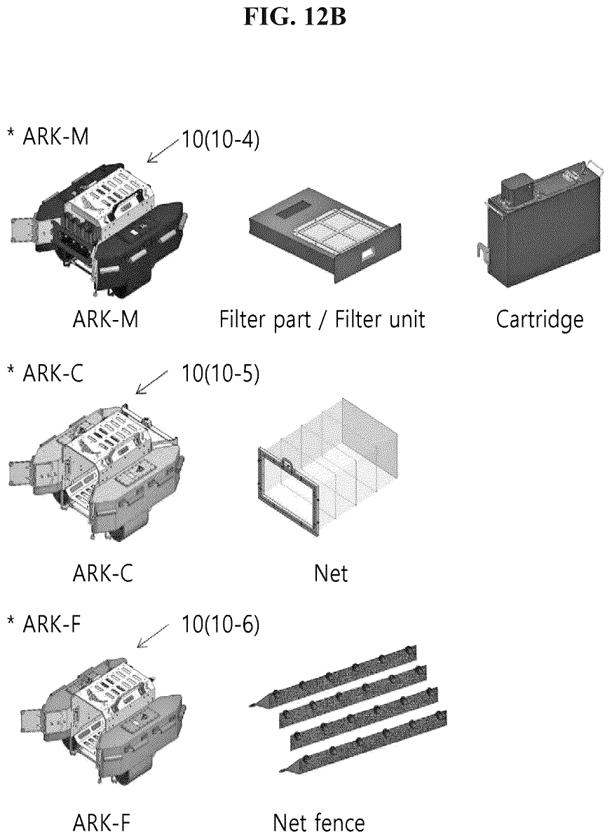

FIG. 12a shows a status LED.

This may be commonly applied to Embodiments 1 to 6 (especially, Embodiments 3 to 6).

Specifically,

The current status of the equipment can be checked through the LED located on an upper part of the product,

The LED has a different lighting method expressed according to priority, and when a simultaneous situation occurs, a state expression with a high priority is output,

The priority is, “Operation abnormal state=Retrieval complete state>Normal state>Standby state”,

If there is no problem with the body (apparatus 10) or no change in state, it normally constantly blinks in the standby state.

Of course, this is an example, and the LED lighting state or logic may be appropriately changed according to necessity.

FIG. 12b is a diagram regarding the washing of the equipment.

In the retrieval of the equipment,

After retrieving the robot 10, the power of the controller and the equipment is terminated,
the modules for each part are separated to retrieve contaminants,
and after moving the equipment and modules to a washing place, they are washed using high-pressure water.

Specific items to be washed are somewhat different according to the embodiment, as shown in FIG. 12b.

That is, in Embodiment 4, the filter part and the cartridge are washed, in Embodiment 5, the net is washed, and in Embodiment 6, the net fence is washed, and of course, this is a difference that occurs because the parts installed (provided) on the apparatus (for example, 10-3) that becomes the basic platform are different according to the embodiment.

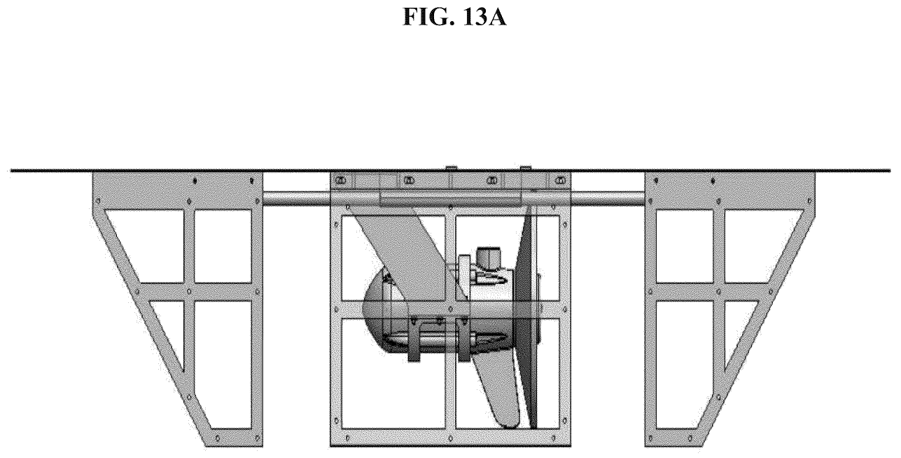

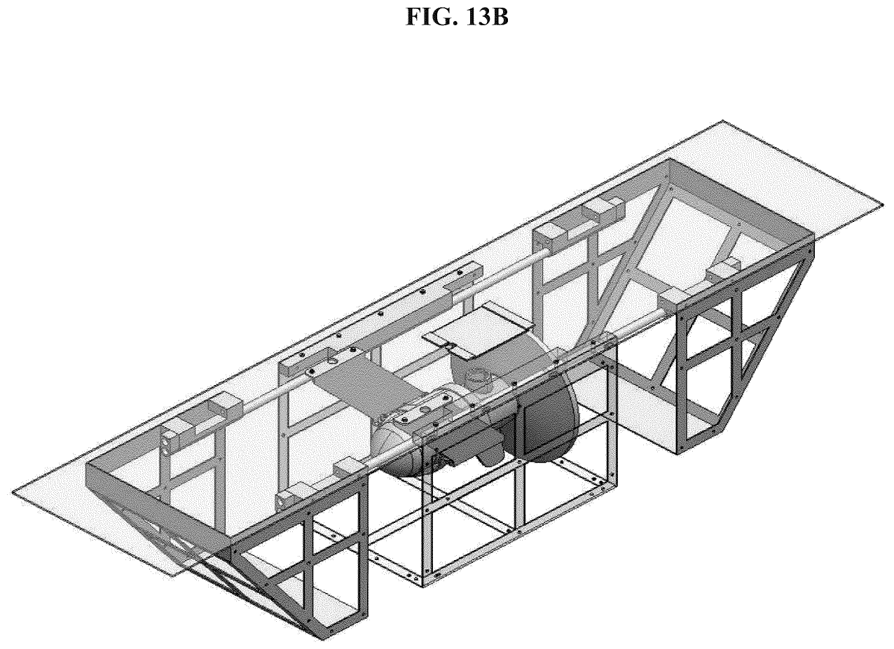

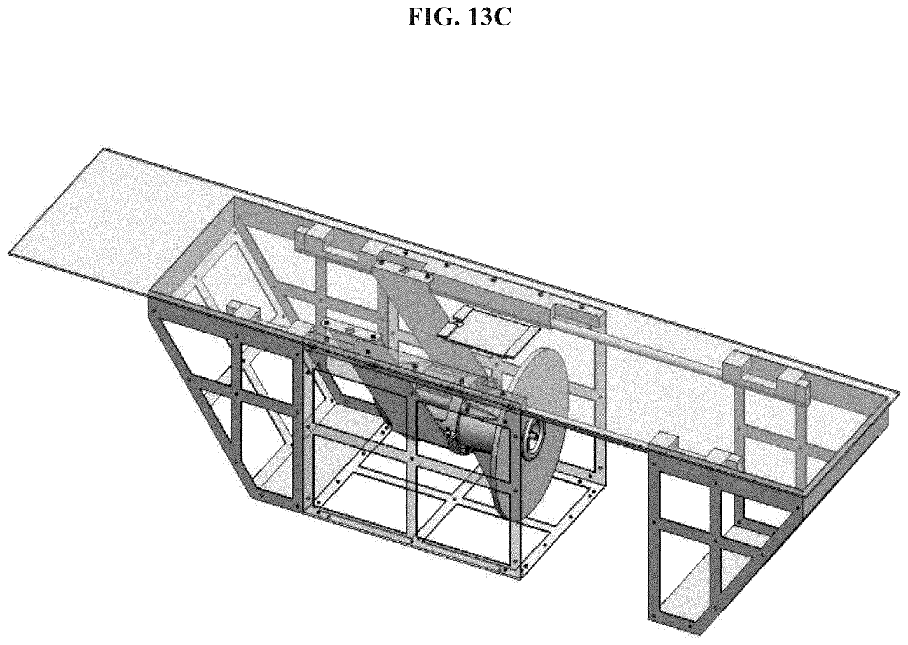

FIGS. 13a to 13c are diagrams showing a Propulsion body guard according to the present invention.

The Propulsion body (also referred to as impeller) is also shown by reference numerals 30-1, 30-2, 30-3, and 30-4 of FIG. 1b (Embodiment 1), and is also shown at a lower right of the drawing in FIG. 2a (Embodiment 2).

A Propulsion body that performs the same function also exists, of course, in Embodiments 3 to 6, and exists at a lower part of the apparatus 10.

In Embodiments 1 to 6, the Propulsion body (impeller) is exposed, but as a modification thereof, the degree of exposure can be somewhat lowered by installing the Propulsion body guard shown in FIGS. 13a to 13c.

Specifically, looking at FIG. 13a (side view), it is shown that the Propulsion body (impeller) is installed below a plate material. In FIG. 13a, the proceeding direction of the apparatus 10 is to the left. That is, the Propulsion body exerts a propulsion force toward the right side of FIG. 13a (that is, the rear of the apparatus 10) to make the hull (apparatus 10) advance to the left side of FIG. 13a (that is, the front of the apparatus 10).

Looking at the side view of FIG. 13a, there exists a member divided into several frames just like a window, and although it is difficult to know just from the drawing, the inside of the approximately rectangular part is padded with a mesh, so that fluid passes through easily and it is made difficult for waste having a certain size to approach the vicinity of the Propulsion body.

FIG. 13b shows the side view shown in FIG. 13a as a perspective view.

It is shown that the Propulsion body is installed below the plate shown transparently. This plate shown transparently, in actuality, will generally be a case that is not transparent (a metal plate or a resin plate forming a part of the hull), and is shown transparently for convenience to easily grasp the internal structure.

Looking at FIG. 13b, (i) a front region of the Propulsion body, (ii) a region where the Propulsion body is (middle region), and (iii) a rear region of the Propulsion body approximately exist as three regions, and among these, the region where the Propulsion body is (ii) (middle region) is enabled to move forward and backward by a rail.

FIG. 13c shows a state in which the region where the Propulsion body is (middle region) has moved forward by sliding.

As also mentioned regarding FIG. 13b, the region where the Propulsion body is (ii) (middle region) is enabled to move forward and backward by a rail, and in FIG. 13c, the region where the Propulsion body is (middle region) actually moves forward and is in contact with the front region.

Although not well shown just by the illustration, since a mesh is attached to each and every window-like section, as described above, fluid can reach the Propulsion body, but waste having a certain volume cannot reach the Propulsion body, so the Propulsion body is protected.

To explain the Propulsion body guard differently, it is as follows.

The Propulsion body guard is a means for blocking the influx of marine debris and, at the same time, maximizing the utilization of propulsion performance. Most of its housing is made of a mesh net, and front and rear opening and closing is possible. The openable and closable part can be opened and closed through the water stream of the Propulsion body. This is to, at the same time, resolve the loss of propulsion performance due to the mesh net when propulsion force is obtained by pushing out the water stream during propulsion, and to utilize the fact that when the water stream comes out, waste influx does not occur due to the flow of water exiting the housing.

In FIGS. 13a to 13c, three regions are presented, and among them, it was explained that only the middle region moves, but it is not necessary to be limited to this, and if necessary, it may be changed so that the front region and the rear region move.

Even in the case where only the middle region moves, the middle region may be controlled to attach to the front region or attach to the rear region by electronic control, or the middle region may be made to move forward or backward naturally (without separate power, by inertia, etc.) according to the flow of water or the forward/backward movement of the apparatus 10.

For example, if a situation occurs such as the apparatus 10 moving forward, or the water stream flowing from the front to the rear of the apparatus 10, the middle region may naturally move toward the rear region and be attached. In this case, although an open space is created between the front region and the middle region, it is not easy for marine contaminants (whether solid or fluid) to enter the open space because there is a water stream discharged from the Propulsion body. And, since a mesh is installed in most of the regions of the Propulsion body guard excluding the open space, a certain degree of protection is also provided in other parts.

Conversely, if a situation occurs such as the apparatus 10 moving backward, or the water stream flowing from the rear to the front of the apparatus 10, the middle region may naturally move toward the front region and be attached (the situation shown in FIG. 13c). In this case, although an open space is created between the middle region and the rear region (see FIG. 13c), it is not easy for marine contaminants (whether solid or fluid) to enter the open space because there is a water stream discharged from the Propulsion body. And, since a mesh is installed in most of the regions of the Propulsion body guard excluding the open space, a certain degree of protection is also provided in other parts.

Of course, what is described above is an example, and it is not necessarily limited to such operation, and if necessary, it may be made to be a situation like FIG. 13c (that is, ‘a situation where the open space is at the rear’) during forward movement of the apparatus 10, and to be ‘a situation where the open space is at the front’ during backward movement of the apparatus 10.

Apart from FIGS. 13a to 13c, as one feature of an embodiment of the present invention, there is [a feature] that enables distance measurement with objects through an AI technology that mimics LIDAR during camera-based aquatic monitoring, and through this, informs a robot 10 operator of a collision risk or enables use as data during avoidance navigation.

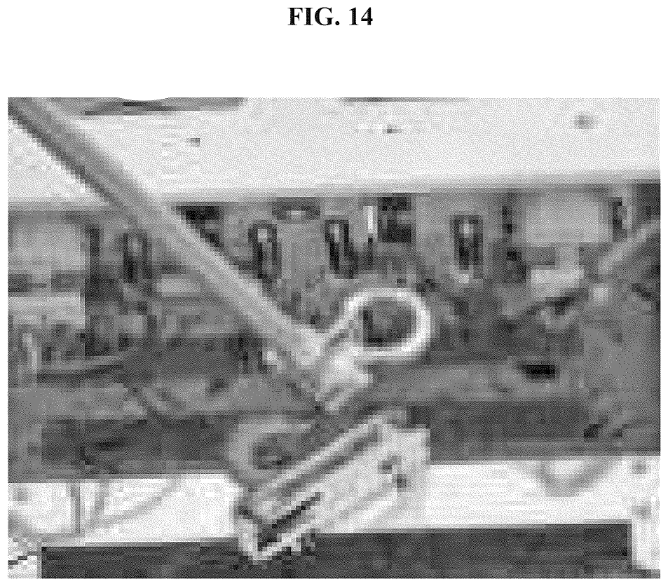

FIG. 14 is a diagram showing a Connecting equipment.

Looking at FIG. 7a (the apparatus 10-5 of Embodiment 5), an illustration of the solid contaminant retrieval module (net) alone and an illustration of a coupled state are shown, and looking at FIG. 7c (also Embodiment 5), a state in which the solid contaminant retrieval module (net) is separated is shown.

Furthermore, looking at FIG. 9a (the apparatus 10-6 of Embodiment 6), an illustration of the fence module (net fence) alone and an illustration of a coupled state are shown, and looking at FIG. 9c (also Embodiment 6), a state in which the fence module (net fence) is separated is shown.

Although it may be thought to be conventional that the assembly and disassembly of such a solid contaminant retrieval module (in the case of Embodiment 5) and fence module (in the case of Embodiment 6) are performed after lifting and moving the apparatus 10 to a mothership (also referred to as ‘response vessel’) or land, in the present invention, they can also be attached and detached in a separated state (that is, a state where the apparatus 10 is launched on the water, not a state where the apparatus 10 is lifted and moved to the mothership or land. This launched position may be a site for processing marine contaminants (oil water, etc.)), without necessarily lifting and moving the apparatus 10 to the mothership or land, and an attachment/detachment equipment for this will be described below.

A part (attachment/detachment equipment) (also referred to as Connecting equipment) to be utilized when attaching or detaching the solid contaminant retrieval module or the fence module to or from the platform (that is, 10-3) in a separated state is as shown in FIG. 14.

The attachment/detachment equipment is a form in which (i) at an end of a pole, (ii) a hook for hanging on a crane and (iii) a part for ease of coupling between modules are provided.

The part indicated in red is the hook of (ii) above, and the opposite side thereof is (iii) above, which is a place for hanging on the recovery part module and the fence module. (Of course, a form in which the hook hangs on the recovery part module and the fence module, and the opposite side thereof hangs on the apparatus 10 is also possible.)

Although not limited to this, the attachment/detachment equipment is a structure in which the hook of (ii) above and the module coupling part of (iii) above face each other, and the pole of (i) above is provided to be orthogonal to (ii) and (iii) above.

Without lifting the apparatus 10 to the mothership or land, in a state where the apparatus 10 is launched, a person on the mothership or land, using the attachment/detachment equipment, (i) grasps an end (one end) of the pole, (ii) hangs the hook at the opposite end (the other end) of the pole onto the apparatus 10, (iii) hangs the module coupling part on the opposite side of the hook onto the recovery part module or the fence module, and separates the pole by pressing a switch, not shown, which may be disposed at the one end of the pole.

Then, by (ii) and (iii) above, a state is achieved in which the apparatus 10 and the recovery part module (or fence module) are coupled, and the pole of (i) above can be separated and stored by the user.

According to such an attachment/detachment equipment, the solid contaminant retrieval module (fifth embodiment) and the fence towing module (sixth embodiment) can be assembled and disassembled in a separated state without retrieving the robot 10 at the waterside. This has the effect of minimizing exposure of workers to serious disasters at the site. To add a word, if it is a site for retrieving oil water, from the perspective of a user on the mothership, there is a large difference between ‘the apparatus 10 may remain launched on the water’ and ‘the apparatus 10 must be lifted from the water and moved to the mothership’ when installing the net (Embodiment 5) or the fence (Embodiment 6). If the apparatus 10 must be lifted from the water and moved to the mothership, the apparatus 10, which is stained with oil, comes to the closest place to the user (worker), and thus health damage such as exposure to harmful substances accordingly cannot be ignored. On the other hand, if the net or fence can be attached to the apparatus 10 even while the apparatus 10 is launched on the water, even if it is inevitable that the mothership goes near the apparatus 10, at least the apparatus 10 is not lifted to the mothership and does not come to the closest place to the user (worker), so it can be seen that a relatively safer working environment is created. This is true in terms of safety, and it is also more advantageous in terms of work efficiency.

In other words, in the case of the corresponding modules, a worker can separate and assemble them in a state separated from the robot (apparatus 10) in an aquatic environment, without directly taking the robot (apparatus 10) out at the waterside. What makes this possible is the attachment/detachment equipment shown in FIG. 14 and described above. A part that is easy to couple to the module of the robot 10 and also easy to couple to a crane is attached to the end of the long pole, so that the worker first couples [it] to the module of the robot 10 using the corresponding equipment (attachment/detachment equipment), and thereafter, it is a method of separating the corresponding module without lifting the robot 10 by hanging [it] on a crane hook that comes down. This is an efficient means that shortens the work time of putting in and taking out the robot at the site.

As an additional feature of an embodiment of the present invention, unrelated to FIG. 14, the following point also exists.

It is made possible to monitor not only an Input value (for example, current or electric power) but also an Output value (for example, current or electric power) of an actuator (recovery part, Propulsion body) on the system (apparatus 10), and by analyzing the corresponding data, it is possible to infer a state of the robot's actuator.

Monitoring the current output value has the following advantages. First, to exemplify one situation, an Input value is set so that 30% output can be produced from the Propulsion body. However, if foreign substances are stuck, the Propulsion body is unable to rotate well, and at this time, it is impossible to know whether or not foreign substances are stuck with simply the Input value. This is because the Input value is simply at a level of giving a command as a code, so it only gives a certain command to rotate 30%, but it is impossible to know if it is rotating well. However, if the Output value becomes known, it becomes possible to receive feedback on whether 30% of Output actually comes out when 30% of Input is instructed, and through this, it is possible to check if the motor is actually doing about 30% of work. Through this, the state of the motor can be inferred, and an abnormal state can be notified to the worker. This function allows monitoring by attaching a current measurement module or sensor to the corresponding wire side when the Propulsion body draws power from the battery within the system board. Therefore, it is possible to infer what state it is in by looking at the tendency of the current output value, such as the Output value itself not coming out because the Propulsion body state is a problem, or the Output value becoming extremely high because foreign substances are stuck (if foreign substances are stuck, it continuously draws an immense amount of current until the Propulsion body rotates), and through this, follow-up measures such as presenting expected problems to customers are possible.

Furthermore, another feature of the present invention is as follows.

A capacity is estimated by utilizing an aquatic monitoring camera so that a retrieval amount of marine debris can be known, and, the amount of retrieved waste can be estimated through an input value (for example, current or electric power), an output value (for example, current or electric power), and driving speed data, which are input to the Propulsion body of the robot 10.

As a contaminant collection amount estimation solution of the robot 10,
analyzing the contaminant collection amount by camera through a camera at an upper rear part of the robot 10; and
at this time, considering the difficulty in estimating the entire capacity of waste in the water, reinforcing the waste amount estimation value with the following additional solution:
(i) That is, estimating a driving speed of the robot (hereinafter, referred to as ‘Speed A’) through sensor fusion of data from GPS and IMU (Inertial Measurement Unit) sensors, and simultaneously monitoring Input and Output data of the Propulsion body through a system box.
(ii) acquiring a driving speed of the robot (hereinafter, referred to as ‘Speed B’) corresponding to the current Input and Output data, based on a pre-calculated propulsion speed table (a data table in which the propulsion speed of the robot is calculated based on Input and Output data of the Propulsion body in an environment without currents and waves).
(iii) determining a speed propulsion degradation level of the robot through a difference between the two speeds (Speed A−Speed B).
(iv) reinforcing the marine debris amount value estimated by the camera, through the corresponding data.

FIGS. 15a to 15h show Embodiment 7 of the present invention, and are mainly for explaining the cartridge 60.

FIG. 15a is an example of the present invention according to Embodiment 7, and is not essentially different from Embodiments 1 to 6, but the arrangement or outer appearance of each constituent element is somewhat different.

In the water surface floating layer removal apparatus 10 according to Embodiment 7 of the present invention, a contaminated water inlet 20 (contaminated water retrieval part) (due to the angle of the illustration, it is not well shown in FIG. 15a, but see FIG. 15b, etc.) is disposed at a front surface (left side in the drawing), which is the proceeding direction of the movable hull 10. Behind the contaminated water inlet 20, a storage part 40 (internal storage container) exists where the introduced contaminated water is stored. An interior of the contaminated water inlet 20 of the hull 10 and the internal storage container 40 is connected. And, rearward of the internal storage container 40 (right side in the drawing), there is a detachable/attachable external storage container 60.

FIG. 15b is a perspective view of the apparatus according to an embodiment of the present invention, seen obliquely from the front side.

Unlike FIG. 15a which is seen obliquely from the rear side, FIG. 15b is seen obliquely from the front side, and is a side cross-sectional view with some members omitted, so that the internal structure can be confirmed.

The apparatus 10 of the present invention basically has a basic operation principle of [contaminated water is introduced through the inlet 20->oil is stored in the storage part 40 (oil-water separation proceeds due to filter and density difference)->after oil-water separation, clean water is discharged to a lower part of the filter HF2].

Although it will be described in detail later, the approximate principle is that the retrieved oil passes over the inclined surfaces (uw1 and uw2 of FIG. 15c) and gathers in the region near the rear sea level of the internal storage part 40 (A2 of FIG. 15c), and by intensively retrieving (A3 of FIG. 15c) only the gathered oil generated by the specific gravity difference, it becomes possible to accurately retrieve only the desired contaminated water.

If a lot of oil is retrieved, the oil comes to be stacked in the storage part 40 (internal storage container), and if this oil is not continuously discharged, there is a problem in that the retrieval amount gradually decreases and the oil may leak out. The present invention can continuously retrieve only oil by operating a pump in real time, so the retrieval amount can be continuously maintained, and it can be used smoothly until the external storage container 60 is full.

The contaminated water (for example, oil) extracted from the internal storage part 40 (internal storage container) is proceeded to move to the external storage container 60 (cartridge) through a pump.

The above is a rough explanation, and if explained one by one by constituent element, it is as follows.

The contaminated water inlet 20 includes, for example, an inlet 21 and an impeller 31.

In FIG. 15b, two each of the inlet 21 and the impeller 31 are shown, but it is not limited to this.

In a state where the hull 10 is floating on the water surface, the water surface comes to be within a height range of the inlet 21, allowing contaminated water to be introduced according to the advance of the hull 10 (proceeding in the left direction in FIG. 2), and in front of this inlet 21, a filtering means (not shown) may be installed to block an influx of large-sized solids that can float in the contaminated water.

Furthermore, although not shown in FIGS. 15a and 15b, near the bottom of the hull 10, an impeller (not shown) (separately from the impeller 31 of the contaminated water inlet 20, a separate impeller for the propulsion of the hull 10) is installed and can move the hull 10 forward and backward. For example, the impeller (not shown) may be two, but the number thereof is adjustable according to necessity.

The outlet 50 (discharge part) is a part where the water remaining after oil is separated from the introduced contaminated water is discharged. In FIG. 15b, the outlet 50 is at a lower part of the hull 10, but according to necessity, it may be disposed on a rear surface, may be disposed at a lower end of the rear surface, or may be disposed at a rear part of a bottom surface. However, considering the external storage container 60 to be described later, it is good that the outlet 50 is at the lower part of the hull 10.

The outlet 50 includes a lower filter HF2.

In FIG. 15b, the contaminated water (for example, oil water) introduced through the inlet 21 passes through the connecting part 1000, is introduced into the internal storage container 40 (especially, 40-1 of the front part), and moves to the further rear internal storage container 40 (that is, 40-2 of the rear part) after passing through rough filtering at the vertical partition VW. The vertical partition VW may be a simple structure of a filter net that performs lower-performance filtering than the upper filter HF1 and the lower filter HF2 to be described later. This vertical partition VW (storage part partition) may perform full-scale filtering, or it is sufficient for it to serve a role of somewhat slowing or hindering the flow of the fluid. Even just hindering (delaying) the flow can increase the time or probability for oil to float to the top due to the specific gravity difference.

In FIG. 15b, the impeller 31 is illustrated as a means for introducing/retrieving oil water (water and oil) at the inlet 21, but it is not necessarily limited to the use of the impeller 31, and for example, other examples using a pump or the like are also possible.

In the internal storage container 40 (especially, 40-2), oil floats to the top and water sinks to the bottom by a specific gravity difference, and the water is discharged through the outlet 50 after passing through the upper filter HF1 and the lower filter HF2.

Meanwhile, in addition to the upper filter HF1 and the lower filter HF2, a separate small window (or small filter SF) exists on a front side of the upper filter HF1, and water may also be discharged after passing through the small filter SF and the lower filter HF2. The flow of contaminated water (water and oil) will be described later in FIG. 15c.

And, the storage part 40 is shown, wherein both (left and right of the hull) outer walls of the storage part 40 (see FIG. 15a, etc., in an uncut state) may include a Buoyant body providing buoyancy. The buoyancy may be provided from the left and right sides of the storage part 40, and may be provided from the bottom side of the storage part 40. It will be preferable to provide buoyancy slightly from all of the left, right, and bottom sides of the storage part 40.

The degree of buoyancy is appropriate to submerge the impeller 31 by about half. Half does not mean exactly 50%, and may be about 40% to 60%. Depending on the case, it may be submerged by about 30% to 70%. Thus, by the action of the impeller 31 half-submerged in water, the contaminated water appropriately moves toward the storage part 40 inside the hull 10.

Of course, it is preferable that the separate impeller (not shown, a separate member from the impeller 31) that exerts propulsion force for the forward, backward, left, and right movement of the hull 10 is all submerged in water. Only the inlet impeller 31 disposed near the contaminated water inlet 20 is submerged about half way in the water surface.

FIG. 15c shows [it], focusing mainly on the flow of contaminated water.

In FIG. 15c, a dark arrow (or a black arrow) indicates a flow of oil, and a light-colored arrow (or a blue arrow) indicates a flow of water.

Of course, although the flow (the flow of water and the flow of oil) is not clearly distinguished like these arrows, it is for conceptually showing an approximate flow in a case where oil water is introduced through the contaminated water inlet 20.

In FIG. 15c, although it is indicated as sea level, it is not limited to the sea, and is applicable anywhere where there is contaminated water (or more broadly, contaminated liquid).

The buoyancy of the hull 10 is adjusted so that the water surface is at an intermediate level of the impeller 31. That is, approximately, above the axis of rotation of the impeller 31 is not submerged in water, and below the axis of rotation will be a state of being submerged in water. At this time, the impeller 31 introduces contaminated water and sends it toward the connecting part 1000.

Furthermore, even if it is not necessarily water and oil, it is of course applicable if it is about the retrieval and separation of two or more liquids that can be separated by a specific gravity difference, and the most typical example given is contaminated water, which is a mixture of oil and water.

In FIG. 15c, the introduced oil passes through the inlet 21, passes through the connecting part 1000, moves to the front internal storage container 40-1, and then generally moves to an upper part of the rear internal storage container 40-2 after passing through the vertical partition VW. A part of the oil may move from the front internal storage container 40-1 to a space below it through the front horizontal baffle 2000, but in many cases, it floats up again to the front internal storage container 40-1.

Meanwhile, regarding the oil moving from the front internal storage container 40-1 to the rear internal storage container 40-2 and then floating up, both the upper wall uw1 of the front internal storage container 40-1 and the upper wall uw2 of the rear internal storage container 40-2 are in a shape such that the walls uw1 and uw2 become higher as they go rearward. In this case, due to these inclined walls uw1 and uw2, the oil easily moves rearward.

If a comparative example is assumed in which, unlike the drawing, the upper walls uw1 and uw2 are horizontal, it can be easily understood that oil will be generally uniformly floating on an upper part in the front internal storage container 40-1 and the rear internal storage container 40-2 (the two together are also referred to as the internal storage container 40). However, according to the present invention (as shown), not the comparative example, the upper walls uw1 and uw2 become higher as they go rearward, so the oil easily moves rearward, and as a result, the oil, rather than existing over the entire water surface of the internal storage container 40, generally gathers in the oil storage region A2 on the rear side, and also has a tendency to gather more in the oil concentration region A3.

This approximate flow of oil can be confirmed through the dark arrow (black arrow).

And, the introduced water passes through the inlet 21, passes through the connecting part 1000, moves to the front internal storage container 40-1, and then generally moves to a lower part of the rear internal storage container 40-2 after passing through the vertical partition VW. A part of the water moves from the front internal storage container 40-1 to a space below it through the front horizontal baffle 2000, and is discharged after passing through the small filter SF (it is permissible for it to be a small window and not necessarily a filter) and the lower filter HF2.

And, another part of the water generally moves to a lower part of the rear internal storage container 40-2. This water moves from the rear internal storage container 40-2 to a space below it through the rear horizontal baffle 3000, and is discharged after passing through the upper filter HF1 and the lower filter HF2.

This approximate flow of water can be confirmed through the light-colored arrow (blue arrow).

Although not limited to this, the filtering performance, relatively, may be high for the upper filter HF1 and the lower filter HF2, intermediate for the small filter SF, and low for the front horizontal baffle 2000 and the rear horizontal baffle 3000.

FIG. 15d is a diagram similar to FIG. 15a, but is shown so that the attached/detached state of the external storage container 60 is more clearly revealed.

That is, FIG. 15d is a diagram schematically showing how the external storage container 60 is attached to the hull.

As described above, the external storage container 60 is a detachable method, and it can also be confirmed that handles are attached on both sides for convenience of attachment/detachment. It is also easy to replace it with another external storage container 60 according to necessity.

This detachable external storage container 60 may also be called a cartridge 60.

FIG. 15e is a perspective view of the external storage container 60 of FIG. 15d.

The left side of FIG. 15e is an upper side perspective view, and the right side of FIG. 15e is a lower side perspective view.

In the lower side perspective view on the right side of FIG. 15e, a state in which the filter is separated is shown for convenience of explanation.

This external storage container 60 is a part of the semi-submersible oil recovery unit 10 of the present invention, and is an oil storage device 60 that can check an automatic replacement time while simultaneously proceeding with oil-water separation inside the storage device 60 when contaminants, in which oil and water are mixed together, are introduced from inside the oil recovery unit 10.

FIG. 15f is a perspective view of a cross-sectional view of the external storage container 60.

The filter 113 at the lower left of FIG. 15f can be slid and fitted into the right side thereof.

And, the first partition 115 partitioning the first stacking section B1 and the second stacking section B2 is formed with vertical slits at a predetermined height, and a lowermost end of the partition is an open structure, and the second partition 117 partitioning the second stacking section B2 and the third stacking section B3 is a structure in which a filter is applied to almost the entire surface. In this case, since the degree of separation of contaminants and water at the second partition 117 is higher than the separation of contaminants and water at the first partition 115 (that is, oil-water separation is done better), it may also be expressed that the separation force of the second partition 117 is higher than the separation force of the first partition 115. However, this is an example, and is not limited to this. As another example, the first partition 115 may also have a structure similar to the second partition 117.

That is, two vertical partitions 115 and 117 having different shapes are formed inside the oil storage device 60 (external storage container). The first partition 115 has holes only at a sea level position and a lowermost position, and serves a role of floating oil above the sea level. The second partition 117 uses a mesh net filter over a wide area to slow down movement using the viscosity of the contaminants, so that there is no malfunction of the sensor. It also serves a role of filtering internal contaminants.

The first partition 115 and/or the second partition 117, broadly seen, may perform full-scale filtering, or may serve a role of somewhat slowing or hindering the flow of fluid, rather than full-scale filtering. This is because even just hindering (delaying) the flow can increase the time or probability for oil to float to the top due to the specific gravity difference. However, it is better for filtering to be done in order to obtain a clearer separation. In the drawings, the first partition 115 and the second partition 117 are shown as the cartridge partition, but the cartridge partition is not necessarily limited to two, and may be one, or three or more. However, it is good for there to be two from the perspective of processing time, filtering effect or ease, balance of appropriate separation degree and processing time, etc.

FIG. 15g assumes a case as a comparative example where the partitions 115 and 117 are not in the external storage container 60.

As shown in FIG. 15g, it can be seen that as the inflow amount of contaminated water increases, and as time passes, the degree of separation of oil and water does not become that high.

FIG. 15h assumes a case as an invention example (cartridge) where the partitions 115 and 117 are in the external storage container 60.

As shown in FIG. 15h, it can be seen that as the inflow amount of contaminated water increases, and as time passes, the degree of separation of oil and water becomes high, and especially, the degree of separation of oil and water becomes higher going from the first stacking section B1->the second stacking section B2->the third stacking section B3.
(i) The photo at the upper left of FIG. 15h is an example where 1 L of contaminated water has been introduced.
(ii) When the introduction proceeds further, it becomes an example where 5 L of contaminated water has been introduced, like the photo at the upper right of FIG. 15h.
(iii) When the introduction proceeds further, it becomes an example where 10 L of contaminated water has been introduced, like the photo at the lower left of FIG. 15h.
(iv) When the introduction proceeds further, it becomes an example where 15~17 L of contaminated water has been introduced, like the photo at the lower right of FIG. 15h.

In the example of FIG. 15h (especially, the photo at the lower right), although the third stacking section B3 is only half-filled with contaminants (for example, oil) on top, if the boundary line between the contaminants and water further descends to a predetermined position (for example, a position where 70~90% of contaminants are filled), the first stacking section B1, where the discharge hole 119 is, will be filled with contaminants almost close to 100% (of course, although it depends on the filtering performance of the first partition 115 and the second partition 117, for example, about 90~100%).

At this time, this is sensed in the third stacking section B3 by the buoyant body 111 and the Hall sensor 121, and it is made possible for a worker to know this through an LED light L, and the worker, seeing this, thinks that this cartridge 60 is full up to the storage limit of contaminants, detaches the cartridge 60, and after detaching, can discharge the contaminants (and some of the water) by operating the discharge lever 103 at another place, causing the discharge hole 119 below the third stacking section B3 to open.

As described above, the filter part hole 123 is opened only when deploying and retrieving the cartridge 60 at the site, and serves a role of blocking the discharge of internal contaminated water while allowing water to be discharged to the outside. The discharge hole 119 is opened only when discharging contaminated water, after separating the cartridge 60 on land after all work is finished. Typically, there is no situation where the two holes 119 and 123 are opened simultaneously.

Through FIGS. 15a to 15h, the cartridge 60 has been described, and this cartridge 60 is not limited to Embodiment 7, and may be applied to Embodiments 1 to 6 according to necessity, and it may be appropriate for it to be applied especially to Embodiment 4.

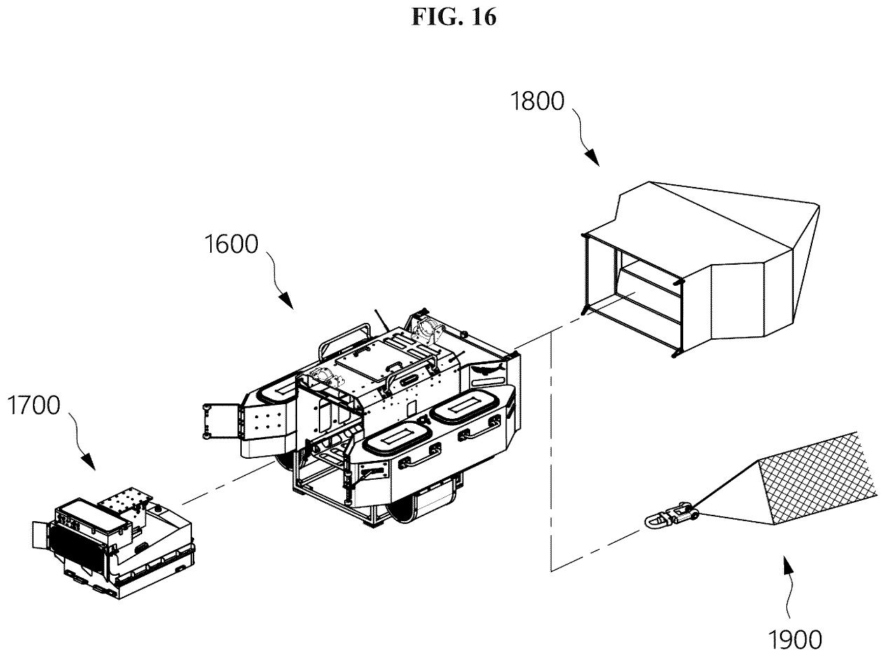

Hereinafter, new embodiments of the present invention will be described with reference to FIGS. 16 to 20. For configurations that perform the same or similar functions as the constituent elements of the existing FIGS. 1 to 15, the same names may be used, but new reference numerals are assigned for clear distinction.

FIG. 16 is an exploded perspective view schematically showing the overall configuration of a modular platform (Water robot) according to a new embodiment of the present invention.

Referring to FIG. 16, the Water robot 1600 according to the present invention comprises a basic platform 1600 that is drivable by itself, and various Add-on equipment that is selectively attached to and detached from the platform 1600 to perform a specific mission.

In this embodiment, three modules are shown as an example of the Add-on equipment. The first Add-on equipment is an oil recovery module 1700 for processing fluid contaminants. The second Add-on equipment is a solid contaminant retrieval module 1800 for retrieving solid contaminants. The third Add-on equipment is a fence module 1900 for gathering contaminants on the water surface.

The biggest feature of such a modular configuration is the point that the necessary functional modules 1700, 1800, and 1900 can be selectively replaced and coupled based on a single platform 1600, according to a site situation or a type of contaminant (fluid or solid).

This enables responding to complex situations or performing various purification tasks with a single Water robot 1600, without needing to deploy separate specialized equipment for each of oil pollution accidents and marine debris collection tasks. Therefore, there is an effect that the economic efficiency of equipment operation and field usability are maximized.

As shown by the dotted line, the oil recovery module 1700 is coupled to an interior of the platform 1600, and the solid contaminant retrieval module 1800 and the fence module 1900 may be configured to be coupled to a rear of the platform 1600.

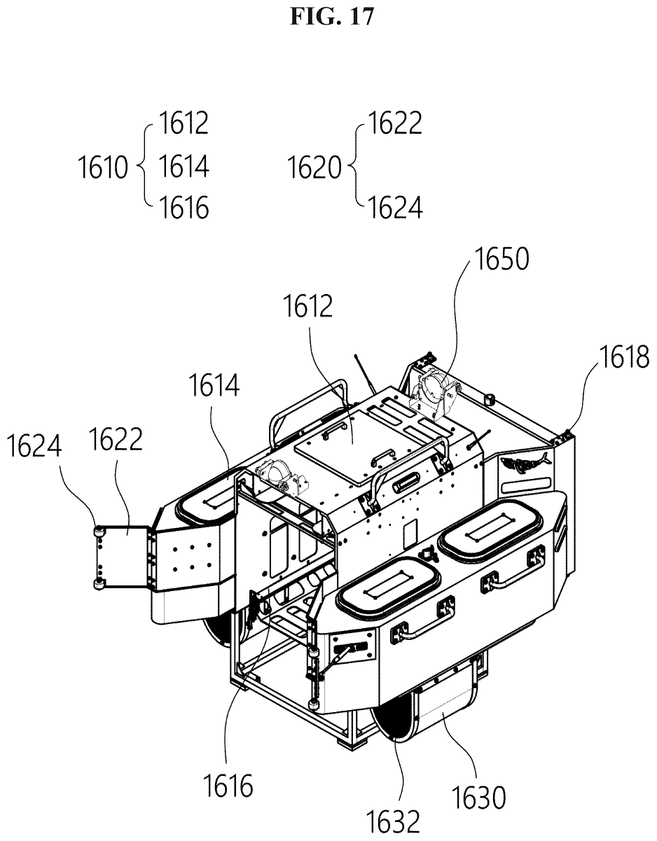

FIG. 17 is a perspective view showing the basic platform shown in FIG. 16, that is, the Water robot 1600, in more detail.

Referring to FIG. 17, the Water robot 1600, as a basic main body before the Add-on equipment 1700, 1800, and 1900 is coupled, may largely include a Body part 1610, a Contaminated matter inlet 1620, and a Propulsion body 1630.

The Body part 1610 forms the main structure of the apparatus, and includes a main frame disposed in the center, where various Control units or a power source (not shown), etc. can be installed. Furthermore, the Body part 1610 may be provided with a camera 1650 for photographing the aquatic environment. The camera 1650 may be installed in at least one or more of various positions such as the front, rear, left, or right of the Body part 1610 according to the operational purpose, and may transmit image data to the Control unit.

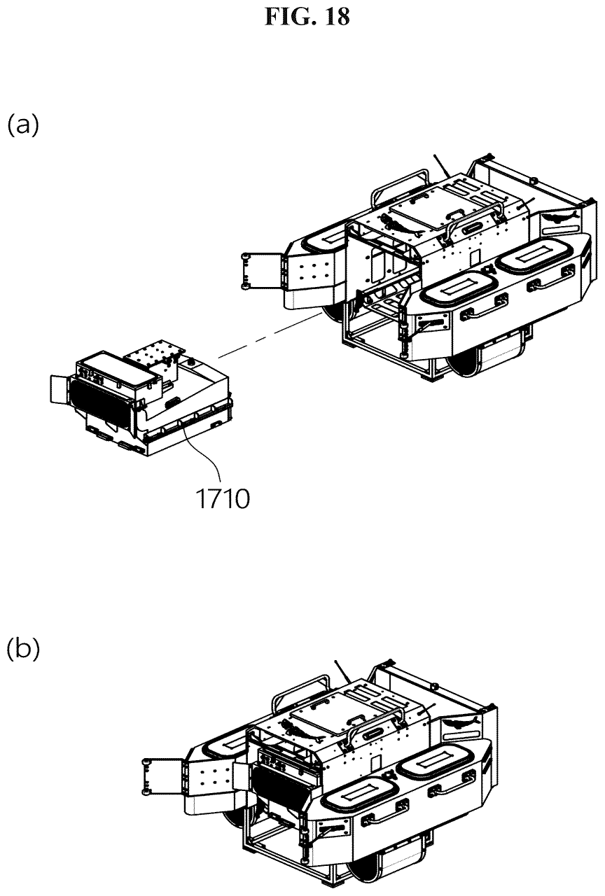

Furthermore, the Body part 1610 includes a pair of Buoyant bodies 1614 coupled to both side surfaces of the main frame 1612 and providing buoyancy to the Water robot 1600. Furthermore, on both inner side surfaces of the main frame 1612, a first guide rail 1616 extending in a horizontal direction is provided so that the oil recovery module 1700 can be coupled in a sliding manner. The first guide rail 1616, for example, may be implemented in a groove or protrusion shape corresponding to a second guide rail (1710 of FIG. 18) provided on a side surface of the oil recovery module.

The Contaminated matter inlet is disposed at a front part of the Body part 1610, and is formed by a pair of guide members 1620 extending forward. The guide members 1620 serve a role of guiding contaminants on the water surface to gather to the center when the Water robot 1600 moves forward.

The Contaminated matter inlet is disposed at a front part of the Body part 1610, and is formed by a pair of guide members 1620 extending forward. The guide members 1620 serve a role of guiding contaminants on the water surface to gather to the center when the Water robot 1600 moves forward.

The Propulsion body 1630 provides power for moving the Water robot 1600 in a desired direction, and in this embodiment, may be installed at a lower part of each of the pair of Buoyant bodies 1614.

Furthermore, around the Propulsion body 1630, a Propulsion body guard 1632 is installed, and blocks marine debris or foreign substances from being introduced and hindering the drive. The Propulsion body guard 1632 is preferably formed in a net or mesh shape structure so as to, at least on the front and rear surfaces where water flow occurs, pass fluid such as water but not pass solid contaminants of a certain size or more.

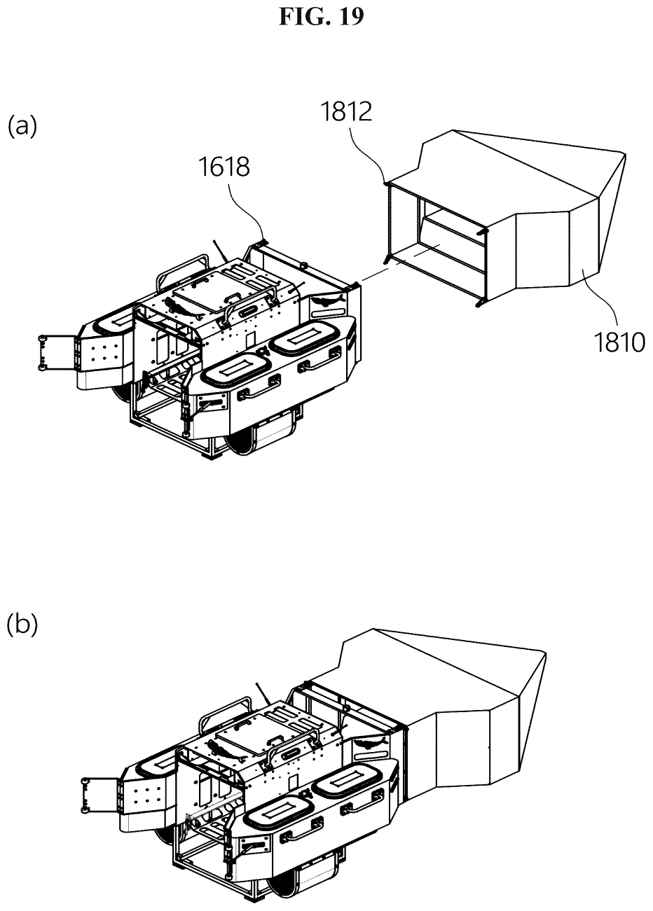

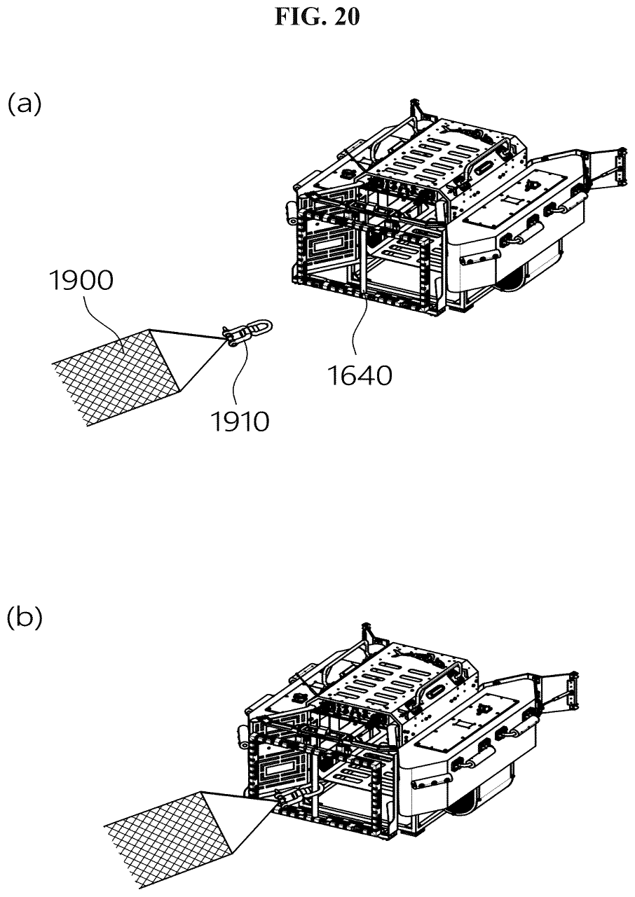

Meanwhile, at a rear of the Body part 1610, a coupling structure for coupling with the Add-on equipment 1800 and 1900 to be described in FIGS. 19 and 20, for example, a hook 1618 or a connecting pipe 1640, etc. may be further provided.

Furthermore, on the Body part 1610 of the Water robot 1600, although not shown in the drawings, a Control unit that controls the overall drive of the apparatus and determines an operational state may be mounted. The Control unit receives data from various sensors provided on the Body part 1610. For example, the Control unit may receive image data from the camera 1650 to recognize contaminants or marine structures and primarily estimate the collection amount. Furthermore, the Control unit may receive data from a current sensor (not shown) that monitors an input electrical signal and an output electrical signal of the Propulsion body 1630, in order to grasp a drive state of the Propulsion body 1630. The Control unit may compare these two signals to infer an abnormal state such as foreign substances being stuck in the Propulsion body or to obtain feedback on whether an actual drive is performed. Furthermore, the Control unit may also perform a dual estimation method of reinforcing the first estimated value of the camera through the difference, by calculating a first driving speed from the GPS or IMU sensor (not shown) and a second driving speed from the current sensor.

FIG. 18 is a diagram showing in detail a process in which the oil recovery module 1700 according to an embodiment of the present invention is coupled to the Body part 1610 of the Water robot 1600.
(a) of FIG. 18 shows a state in which the oil recovery module 1700 is separated from the Body part 1610, and (b) shows a state in which the coupling of the oil recovery module 1700 to the interior of the Body part 1610 is completed, respectively.

To explain the coupling process in detail, as described in FIG. 17, on the Body part 1610 of the Water robot 1600, especially on both inner side surfaces of the main frame 1612, a first guide rail 1616 extending in a horizontal direction may be provided.

Corresponding to this, on both outer side surfaces of the oil recovery module 1700, a second guide rail 1710 having a shape corresponding to the first guide rail 1616 may be formed.

Therefore, a worker, by aligning the second guide rail 1710 of the oil recovery module 1700 with the first guide rail 1616 of the Body part 1610 and pushing it in in a sliding manner, can simply and quickly mount the oil recovery module 1700 to the interior of the Body part 1610.

This sliding coupling method facilitates module replacement, and enables rapid function transition according to the site situation. Especially, in a case where the module must be replaced directly on the water surface without hoisting the Water robot 1600 to land, the utility of such a simple coupling structure is further maximized.

The oil recovery module 1700 coupled in this way can process fluid contaminants introduced through the Contaminated matter inlet internally. For example, the oil recovery module 1700 may include an oil-water separation part 1720 that provides a space where fluid contaminants are separated by a density difference, an oil-water separation filter 1730 that filters the separated oil, and a cartridge 1740 that stores the separated oil.

Especially, it is important that the oil recovery module 1700 is designed so that its inlet or oil-water separation part 1720 exactly matches the height of the water surface, in order to efficiently retrieve oil floating on the water surface. To this end, the pair of Buoyant bodies 1614 of the Body part 1610 may be designed so that the entire Water robot 1600 maintains appropriate buoyancy in a state where the oil recovery module 1700 is coupled. That is, the buoyancy design of the Body part 1610 is set so that the optimal retrieval height of the oil recovery module 1700, which is fixed by the first and second guide rails 1616 and 1710, matches the actual water surface, so that oil retrieval efficiency can be maximized.

FIG. 19 is a diagram showing a process in which the solid contaminant retrieval module 1800 according to an embodiment of the present invention is coupled to the Body part 1610 of the Water robot 1600.
(a) of FIG. 19 shows a state in which the solid contaminant retrieval module 1800 is separated from the Body part 1610, and (b) shows a state in which the coupling of the module 1800 to the rear of the Body part 1610 is completed, respectively.

To explain the coupling method in detail, as described in FIG. 17, at a rear edge of the Body part 1610 of the Water robot 1600, at least one hook 1618 may be provided so that the Add-on equipment can be coupled.

Corresponding to this, the solid contaminant retrieval module 1800 may comprise: a net 1810 for collecting solid contaminants, and a Connecting link 1812 provided on a front frame of the net 1810 and detachably coupled to the hook 1618.

Therefore, a worker can quickly mount or separate the module by simply fastening the Connecting link 1812 of the solid contaminant retrieval module 1800 to the hook 1618 of the Body part 1610. Furthermore, the solid contaminant retrieval module 1800 may be equipped with an electromagnet or a mechanical clamping method instead of the hook method, so that a worker can control the solid contaminant retrieval module 1800 to be automatically coupled or detached from the Water robot through RC adjustment and an LTE-based web program. Through this, the worker can remotely separate the net, in which solid contaminants are collected, and the front frame of the net to lift it from the water, or can couple the solid contaminant retrieval module 1800 to the Water robot.

This simple coupling structure, just as in the case of the oil recovery module 1700 of FIG. 18, facilitates replacing the module on the water surface without needing to hoist the Water robot 1600 to land, and can increase field usability.

The solid contaminant retrieval module 1800 coupled in this way performs a role of collecting and retrieving, inside the net 1810, solid contaminants that are introduced through the Contaminated matter inlet or have passed through a lower part of the Body part 1610, as the Water robot 1600 moves forward.

FIG. 20 is a diagram showing a process in which the fence module 1900 according to an embodiment of the present invention is coupled to the Body part 1610 of the Water robot 1600.
(a) of FIG. 20 shows a state in which the fence module 1900 is separated from the Body part 1610, and (b) shows a state in which the coupling of the module 1900 to the rear of the Body part 1610 is completed, respectively.

To explain the coupling method in detail, as described in FIG. 17, at a rear of the Body part 1610 of the Water robot 1600, a connecting pipe 1640 may be provided so that one end of the fence module 1900 is coupled.

Corresponding to this, the fence module 1900 may comprise: a net fence 1910 (a part of 1900) for gathering contaminants on the water surface, and a connecting part 1912 (a part of 1900) provided on one end of the net fence 1910 and detachably coupled to the connecting pipe 1640.

For example, the connecting part 1912 may be implemented in a hook-type or carabiner form, so that a worker can easily hang it on or separate it from the connecting pipe 1640.

This coupling structure provides a key feature that distinguishes the fence module 1900 from the solid contaminant retrieval module (1800 of FIG. 19). That is, the fence module 1900 is towed in a state where only one end is connected to the Body part 1610, and the other end thereof may be connected to a separate Water robot or a fixture such as land. Through this, collaborative tasks, such as two Water robots towing the net fence 1910 from both sides and efficiently gathering contaminants over a wide range, can be performed.

Although the embodiments of the present invention have been described above with reference to the accompanying drawings, the present invention is not limited to the above embodiments but may be manufactured in various different forms, and it will be understood by one of ordinary skill in the art to which the present invention pertains that other specific forms can be implemented without changing the technical spirit or essential features of the present invention. Therefore, it must be understood that the embodiments described above are illustrative in all aspects and not restrictive.

1. A Water robot configured as a modular platform for retrieving water surface floating contaminants, comprising:
a Body part including a main frame;
a Contaminated matter inlet disposed at a front part of the Body part and receiving contaminants;
a Propulsion body provided in the Body part and exerting a propulsion force to move the Body part in a desired direction; and
Add-on equipment detachably coupled to a rear or an interior of the Body part.

2. The Water robot of claim 1, wherein the Body part comprises:
the main frame disposed at a center; and
a pair of Buoyant bodies coupled to both side surfaces of the main frame and providing buoyancy.

3. The Water robot of claim 1, wherein the Contaminated matter inlet comprises:
a pair of guide members extending forward from both front sides of the Body part and configured to gather contaminants to the Contaminated matter inlet,
wherein the pair of guide members comprises at least one wheel on the edge.

4. The Water robot of claim 2, wherein the Propulsion body further comprises:
a Propulsion body guard installed at a lower part of each of the pair of Buoyant bodies, and surrounding a periphery of the Propulsion body to prevent an influx of marine debris.

5. The Water robot of claim 1, wherein the Add-on equipment is any one of:
an oil recovery module detachably coupled to an interior of the Body part, and storing and separating fluid contaminants introduced through the Contaminated matter inlet;
a solid contaminant retrieval module detachably coupled to a rear of the Body part, and including a net for collecting solid contaminants introduced through the Contaminated matter inlet; and
a fence module including a net fence configured such that one end is detachably coupled to the rear of the Body part, and the other end is connected to a separate Water robot or a fixture.

6. The Water robot of claim 5, wherein the Add-on equipment is an oil recovery module,
wherein the Body part further comprises:
a first guide rail provided on both inner side surfaces so that the oil recovery module is coupled in a sliding manner,
and wherein the oil recovery module comprises:
a second guide rail provided on both outer side surfaces corresponding to the first guide rail;
an oil-water separation part providing a space for fluid contaminants introduced through the Contaminated matter inlet to be separated by a density difference;
an oil-water separation filter disposed at a lower end of the oil-water separation part and filtering oil in the lower part; and
a cartridge storing oil separated onto the oil-water separation part.

7. The Water robot of claim 5, wherein the Add-on equipment is a solid contaminant retrieval module,
wherein the Body part further comprises:
at least one hook provided at a rear edge so that the solid contaminant retrieval module is coupled,
and wherein the solid contaminant retrieval module is:
a net including a Connecting link detachably coupled to the hook.

8. The Water robot of claim 5, wherein the Add-on equipment is a solid contaminant retrieval module,
wherein the Body part and the solid contaminant retrieval module further comprise:
an automatic coupling part capable of coupling or detaching the solid contaminant retrieval module by a worker's remote control,
and wherein the automatic coupling part uses at least one of an electromagnet or a mechanical clamping method.

9. The Water robot of claim 5, wherein the Add-on equipment is a fence module,
wherein the Body part further comprises:
a connecting pipe provided at a rear thereof so that one end of the fence module is coupled,
and wherein the fence module is:
a net fence having a connecting part detachably coupled to the connecting pipe in a hook-type.

10. The Water robot of claim 1, wherein the Body part comprises:
at least one camera provided on an upper part thereof;
at least one current sensor monitoring an input electrical signal and an output electrical signal of the Propulsion body; and
a Control unit determining an operational state of the Water robot or controlling a drive thereof, based on data received from the camera and the current sensor.

11. The Water robot of claim 10,
wherein the Control unit compares and calculates the input electrical signal and the output electrical signal of the Propulsion body received from the current sensor,
to infer an abnormal state of the Propulsion body or to generate feedback on whether an actual drive is performed according to the input electrical signal.
